(19) United States
(12) Patent Application Publication
(10) Pub. No.: US 2026/0214374 A1
(43) Pub. Date: Jul. 23, 2026

(54) BONE-CONDUCTION SPEAKERS AND EARPHONES

(71) Applicant: SHENZHEN SHOKZ CO., LTD., Shenzhen (CN)

(72) Inventors: Guangyuan ZHU, Shenzhen (CN); Lei ZHANG, Shenzhen (CN); Zhao XIE, Shenzhen (CN); Xin QI, Shenzhen (CN)

(73) Assignee: SHENZHEN SHOKZ CO., LTD., Shenzhen (CN)

(21) Appl. No.: 19/571,433

(22) Filed: Mar. 18, 2026

Related U.S. Application Data
(63) Continuation of application No. PCT/CN2023/126028, filed on Oct. 23, 2023.

(51) Int. Cl. H04R 1/10; H04R 1/28; H04R 9/02; H04R 9/06

(52) U.S. Cl. CPC H04R 1/1075; H04R 1/2811; H04R 9/027; H04R 9/066; H04R 2460/13

(57) ABSTRACT

Provided are a bone-conduction speaker and an earphone. The bone-conduction speaker includes a cylindrical housing, a driving assembly, and two sealing plates. The cylindrical housing is enclosed an accommodating space. The driving assembly is disposed within the accommodating space and connected with the cylindrical housing. The sealing plates are respectively disposed at two ends of the cylindrical housing and block the accommodating space. In this way, the present disclosure is configured to limit the driving assembly in the bone-conduction speaker, improve the sound quality of the bone-conduction speaker, and increase the service life of the bone-conduction speaker.

### CROSS REFERENCE TO RELATED APPLICATIONS

This application is a continuation of International Patent Application No. PCT/CN2023/126028, filed on Oct. 23, 2023, the entire contents of which are incorporated herein by reference.

### TECHNICAL FIELD

The present disclosure relates to the technical field of electronic devices, and in particular, to bone-conduction speakers and earphones.

### BACKGROUND

Bone-conduction earphones use a bone-conduction technology to convert sounds into mechanical vibrations at different frequencies. These vibrations are then transmitted through the human skull, the bony labyrinth, the inner ear lymph, the cochlear spiral organ, and the auditory center. At present, the bone-conduction earphones are widely applied in daily life. However, one or more bone-conduction elements in the earphones are often displaced due to vibrations, thereby affecting the sound quality of the earphones.

### SUMMARY

To solve the above technical problem, the present disclosure provides a bone-conduction speaker and an earphone, which are configured to limit a driving assembly in the bone-conduction speaker, improve the sound quality of the bone-conduction speaker, and increase the service life of the bone-conduction speaker.

To solve the above technical problem, the present disclosure provides a bone-conduction speaker. The bone-conduction speaker comprises a cylindrical housing, a driving assembly, and two sealing plates. The cylindrical housing is enclosed an accommodating space. The driving assembly is disposed within the accommodating space and connected with the cylindrical housing. The sealing plates are respectively disposed at two ends of the cylindrical housing and block the accommodating space.

In some embodiments, the bone-conduction speaker includes one or more vibration transmission plates, and the one or more vibration transmission plates are connected with the driving assembly and the cylindrical housing. In an axis direction of the cylindrical housing, the one or more vibration transmission plates are disposed between the driving assembly and the two sealing plates and arranged opposite to the two sealing plates.

In some embodiments, one end of the cylindrical housing is configured in a stepped shape to form a first bearing surface and a second bearing surface with a step difference in the axis direction, and the second bearing surface is closer to an axis of the cylindrical housing than the first bearing surface. The two sealing plates are fixedly supported on the first bearing surface. A peripheral edge of the one or more vibration transmission plates is fixedly supported on the second bearing surface.

In some embodiments, the two sealing plates are fixedly connected with the two ends of the cylindrical housing. A peripheral edge of the one or more vibration transmission plates is fixed to an inner wall of the cylindrical housing.

In some embodiments, the one or more vibration transmission plates are fixedly connected to one end of the cylindrical housing. One of the two sealing plates is fixedly stacked on a side of the one or more vibration transmission plates away from the driving assembly and is arranged at intervals from the cylindrical housing.

In some embodiments, a count of the one or more vibration transmission plates is two, the two vibration transmission plates are respectively fixedly connected to the cylindrical housing, and the two sealing plates are correspondingly disposed on sides of the two vibration transmission plates away from the driving assembly.

In some embodiments, the driving assembly includes a voice coil assembly and a magnet assembly, one of the voice coil assembly and the magnet assembly surrounds the other one of the voice coil assembly and the magnet assembly, and the one of the voice coil assembly and the magnet assembly is fixedly connected to the cylindrical housing. The one or more vibration transmission plates are fixedly connected to the other one of the voice coil assembly and the magnet assembly and to the cylindrical housing. The one or more vibration transmission plates and the two sealing plates are arranged opposite to each other in the axis direction of the cylindrical housing. The one or more vibration transmission plates are configured to elastically constrain a relative movement of the voice coil assembly and the magnet assembly in the axis direction of the cylindrical housing.

In some embodiments, each of the one or more vibration transmission plates is disposed between the other one of the voice coil assembly and the magnet assembly and a corresponding sealing plate in the two sealing plates. The corresponding sealing plate is configured to rigidly constrain a deformation amplitude of the each of the one or more vibration transmission plates in the axis direction of the cylindrical housing to rigidly constrain a relative movement range of the voice coil assembly and the magnet assembly.

In some embodiments, each of the one or more vibration transmission plates includes a central fixing portion, an annular fixing portion surrounding a periphery of the central fixing portion, and a connecting-rod assembly connected between the central fixing portion and the annular fixing portion, the annular fixing portion is connected to the cylindrical housing, and the central fixing portion is connected to the other one of the voice coil assembly and the magnet assembly. In a natural state, the central fixing portion and the corresponding sealing plate have a spacing in the axis direction of the cylindrical housing.

In some embodiments, a distance between the central fixing portion and the corresponding sealing plate is in a range of 0.005 mm to 0.8 mm.

In some embodiments, in the natural state, the central fixing portion is closer to the other one of the voice coil assembly and the magnet assembly in the axis direction than the annular fixing portion. The magnet assembly includes a magnet and two magnetic conducting plates. The two magnetic conducting plates are respectively disposed on two opposite side surfaces of the magnet in the axis direction. Each of the two magnetic conducting plates has a protruding portion protruding toward the central fixing portion, and the protruding portion is fixedly connected to the central fixing portion.

In some embodiments, the voice coil assembly includes two sets of voice coils arranged at intervals in the axis direction. The cylindrical housing is disposed around a periphery of the two sets of voice coils. Projections of the two magnetic conducting plates in a radial direction of the bone-conduction speaker are at least partially overlapped with the two sets of voice coils. The two sets of voice coils have opposite energizing directions.

In some embodiments, the accommodating space is filled with a magnetic fluid, and the magnetic fluid occupies at least a portion of the accommodating space.

To solve the above technical problems, the present disclosure further provides an earphone. The earphone comprises a housing assembly and the above bone-conduction speaker. The housing assembly is provided with an accommodating space. The bone-conduction speaker is disposed within the accommodating space.

Beneficial effects of the present disclosure are as follows: different from existing technologies, in the present disclosure, two sealing plates are disposed on two sides of the bone-conduction speaker to close the cylindrical housing, so that the driving assembly is limited within the accommodating space of the cylindrical housing, thereby preventing the driving assembly from easily falling out of the accommodating space, improving the sound quality of the bone-conduction speaker, and increasing the service life of the bone-conduction speaker.

### BRIEF DESCRIPTION OF THE DRAWINGS

FIG. 1 is a schematic diagram illustrating an overall assembled three-dimensional structure of an earphone according to some embodiments of the present disclosure;

FIG. 2 is a schematic diagram illustrating a three-dimensional structure of a speaker assembly and a portion of an ear hook according to some embodiments of the present disclosure;

FIG. 3a is a schematic diagram illustrating an exploded structure of the speaker assembly shown in FIG. 2 according to some embodiments of the present disclosure;

FIG. 3b is a schematic diagram illustrating an exploded structure of the speaker assembly shown in FIG. 2 according to some other embodiments of the present disclosure;

FIG. 4 is a schematic diagram illustrating a sectional structure along an A-A section line of the speaker assembly shown in FIG. 2;

FIG. 5a is a schematic diagram illustrating another sectional structure along the A-A section line of the speaker assembly shown in FIG. 2;

FIG. 5b is a schematic diagram illustrating still another sectional structure along the A-A section line of the speaker assembly shown in FIG. 2;

FIG. 6 is a schematic diagram illustrating another three-dimensional structure of the speaker assembly shown in FIG. 2;

FIG. 7 is a schematic diagram illustrating a positional relationship between a first central axis and a second central axis of the speaker assembly shown in FIG. 2;

FIG. 8 is a schematic diagram illustrating an exploded structure of a bone-conduction speaker shown in FIG. 3a;

FIG. 9 is a schematic diagram illustrating a sectional structure along a B-B section line of the bone-conduction speaker shown in FIG. 8;

FIG. 10 is a schematic diagram illustrating a three-dimensional structure of an air-conduction speaker shown in FIG. 3a;

FIG. 11 is a schematic diagram illustrating an exploded structure of the air-conduction speaker shown in FIG. 10;

FIG. 12 is a schematic diagram illustrating an exploded structure of a speaker assembly according to some other embodiments of the present disclosure;

FIG. 13 is a schematic diagram illustrating a sectional structure along an A-A section line of some embodiments of the speaker assembly shown in FIG. 12;

FIG. 14 is a schematic diagram illustrating a sectional structure along the A-A section line of some other embodiments of the speaker assembly shown in FIG. 12;

FIG. 15 is a schematic diagram illustrating a sectional structure along the A-A section line of still some other embodiments of the speaker assembly shown in FIG. 12;

FIG. 16 is a schematic diagram illustrating a structure of a vibration transmission plate of the bone-conduction speaker shown in FIG. 8;

FIG. 17 is a schematic diagram illustrating an exploded structure of a speaker assembly according to still some other embodiments of the present disclosure;

FIG. 18 is a schematic diagram illustrating a sectional structure along a C-C section line of the speaker assembly shown in FIG. 17 according to some embodiments of the present disclosure;

FIG. 19 is a schematic diagram illustrating a sectional structure along the C-C section line of the speaker assembly shown in FIG. 17 according to some other embodiments of the present disclosure;

FIG. 20 is a schematic diagram illustrating a sectional structure along the C-C section line of the speaker assembly shown in FIG. 17 according to still some other embodiments of the present disclosure; and

FIG. 21 is a schematic diagram illustrating another sectional structure along the C-C section line of the speaker assembly shown in FIG. 17.

### DETAILED DESCRIPTION

Hereinafter, the present disclosure is further described in detail in conjunction with the accompanying drawings and embodiments. It should be particularly noted that the following embodiments are merely used to illustrate the present disclosure, and do not limit a scope of the present disclosure. Likewise, the following embodiments are only part of the embodiments of the present disclosure rather than all of the embodiments. All other embodiments that may be obtained by a person of ordinary skill in the art without creative efforts shall fall within a protection scope of the present disclosure.

In the present disclosure, reference to an “embodiment” means that a specific feature, structure, or characteristic described in connection with the embodiment may be included in at least one embodiment of the present disclosure. It is explicitly and implicitly understood by those skilled in the art that the embodiments described in the present disclosure may be combined with other embodiments.

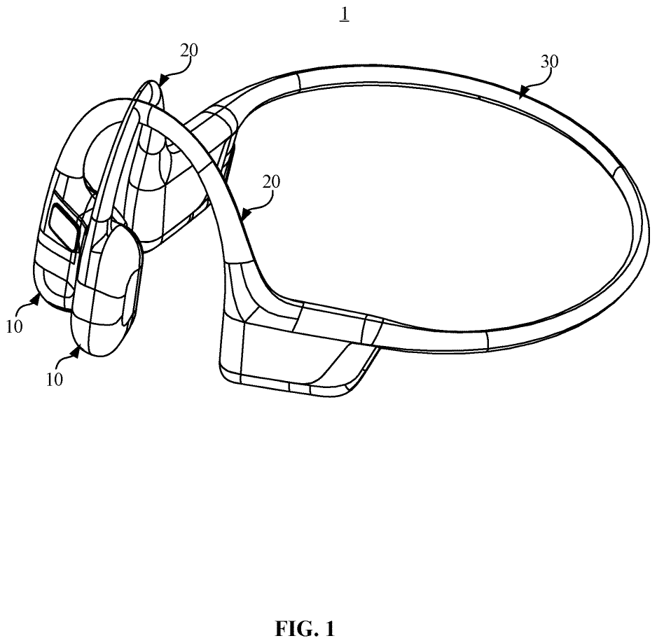

As shown in FIG. 1, an earphone 1 may include one or more speaker assemblies 10, one or more ear hooks 20, and a rear hook 30.

One of the one or more speaker assemblies 10 may include a core module including a speaker, an assembly housing, circuit elements, or the like. The count of speaker assemblies 10 may be two. The two speaker assemblies 10 are respectively configured to transmit a vibration and/or sounds to the left ear and the right ear of a user. The two speaker assemblies 10 may be identical or may be different. For example, one speaker assembly 10 may be provided with a microphone, and the other speaker assembly 10 may not be provided with the microphone. As another example, both of the two speaker assemblies 10 may be provided with the microphone. As another example, one speaker assembly 10 may be provided with a button and a circuit board, and the other speaker assembly 10 may not be provided with the button and the circuit board. The speakers included in the two speaker assemblies 10 may be identical or may be different. Subsequent descriptions herein regarding the speaker assembly 10 may be understood as being detailed descriptions made by taking one of the two speaker assemblies 10 as an example.

The count of the one or more ear hooks 20 may be two. The two ear hooks 20 may be respectively arranged on the left ear and the right ear of the user, so that the speaker assemblies 10 may fit against the face of the user. For example, one ear hook 20 may be provided with a battery, and the other ear hook 20 may be provided with a control circuit or the like. One end of the each ear hook 20 is connected to the speaker assembly 10, and the other end of each ear hook 20 is connected to the rear hook 30. The ear hook 20 may also be referred to as a wearing assembly 20. The ear hook 20 may also be referred to as the wearing assembly 20.

The rear hook 30 may be connected to two ear hooks 20. The rear hook 30 may be used to extend around the back of the neck of the user or the back of the head of the user and may provide a clamping force so that the two speaker assemblies 10 are clamped at two sides of the face of the user, and the ear hooks 20 are more stably arranged on the ears of the user. In some embodiments, the earphone 1 may also not include the rear hook 30, and the speaker assembly 10 may be worn on an ear of the user through the ear hook 20.

In some embodiments, the earphone 1 may also not include the rear hook 30, and the speaker assembly 10 may be worn on the ear of the user through the ear hook 20. In some embodiments, the earphone 1 may not include the ear hooks 20. The speaker assembly 10 may be connected through a head-worn structure or a neck-worn structure, and the speaker assembly 10 may be pressed against the face of the user or stably disposed at the outer side of the ear of the user through the head-worn structure or the neck-worn structure.

Merely by way of example, the following descriptions mainly describe structures such as the speaker assembly 10 of the earphone 1.

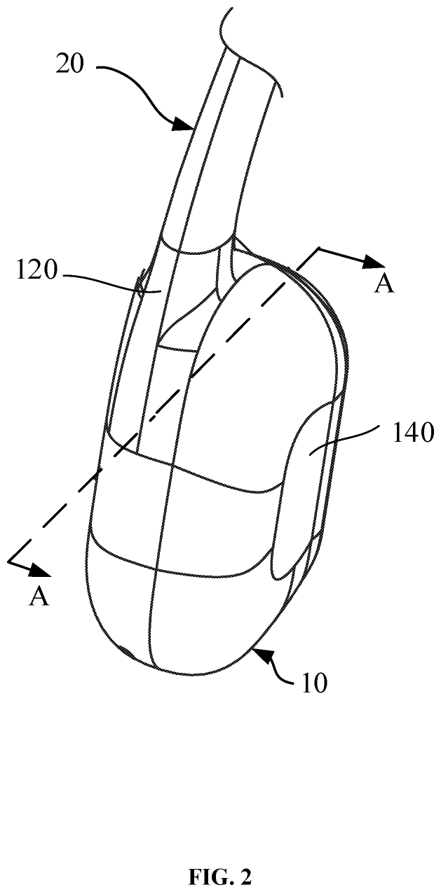

As shown in FIGS. 2 to 4, the speaker assembly 10 includes a housing assembly 100, a bone-conduction speaker 200, and an air-conduction speaker 300. The housing assembly 100 may be provided with an accommodating space 110. The air-conduction speaker 300 may be disposed in the accommodating space 110, and the bone-conduction speaker 200 may also be disposed in the accommodating space 110.

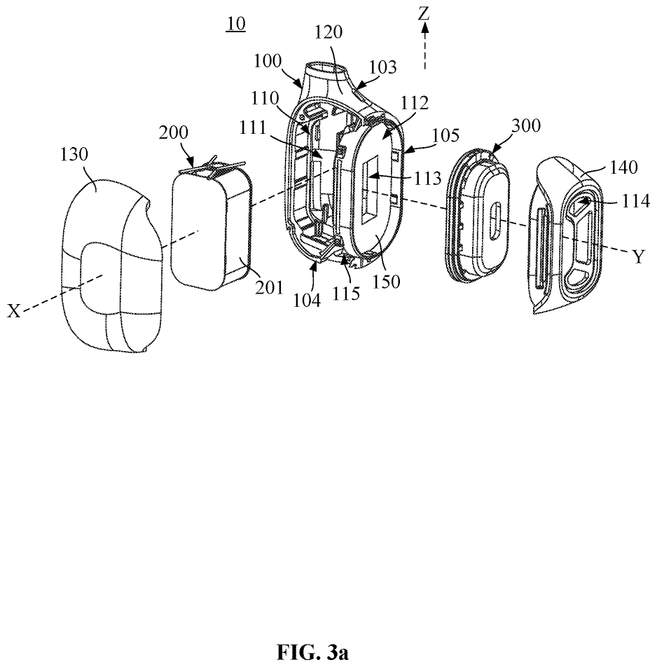

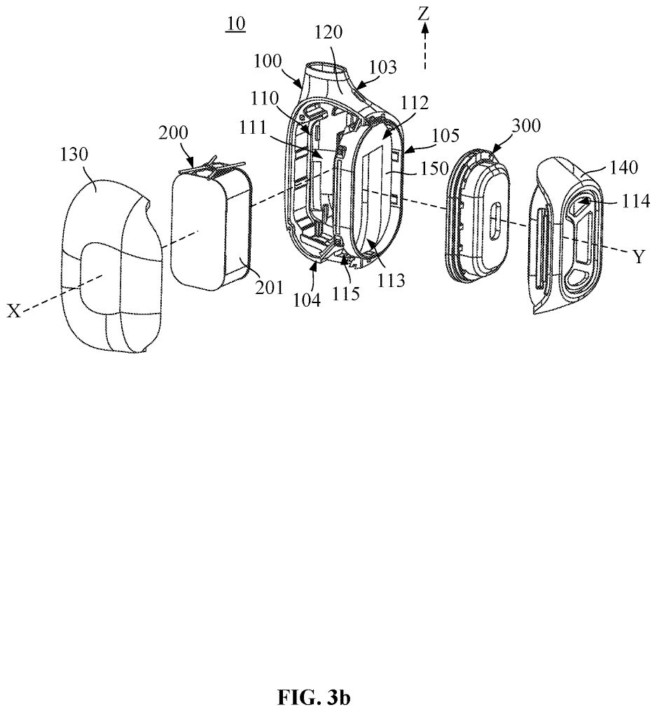

The accommodating space 110 is formed in the housing assembly 100, and the accommodating space 110 accommodates the air-conduction speaker 300 and the bone-conduction speaker 200. The accommodating space 110 may be an integral large space or may be partitioned into two or more small spaces that are either in communication with each other or not in communication with each other. For example, as shown in FIG. 3a, the housing assembly 100 may be provided with a first accommodating cavity 111 and a second accommodating cavity 112. The first accommodating cavity 111 and the second accommodating cavity 112 may be two spaces that are in fluid communication with each other or not in fluid communication with each other.

In some embodiments, as shown in FIG. 3a, the housing assembly 100 may further be provided with a communication hole 113 connecting the first accommodating cavity 111 and the second accommodating cavity 112. In this way, at least the first accommodating cavity 111, the second accommodating cavity 112, and the communication hole 113 may jointly form the accommodating space 110. The bone-conduction speaker 200 may be disposed in the first accommodating cavity 111 and may block the communication hole 113 to isolate the first accommodating cavity 111 from the second accommodating cavity 112. The air-conduction speaker 300 may be disposed in the second accommodating cavity 112. In other embodiments, the first accommodating cavity 111 and the second accommodating cavity 112 may not be provided with the communication hole 113, and the housing assembly 100 may directly isolate the first accommodating cavity 111 and the second accommodating cavity 112 from each other without fluid communication.

The air-conduction speaker 300 is configured to transmit sounds into an ear canal of the user through an air vibration principle, and the bone-conduction speaker 200 is configured to transmit sounds to the user through a bone-conduction vibration manner. The second accommodating cavity 112, where the air-conduction speaker 300 is located, needs to be in communication with an external environment to transmit sound waves through air conduction, while the bone-conduction speaker 200 requires a tightly closed environment to ensure a bone-conduction effect. Therefore, the bone-conduction speaker 200 and the air-conduction speaker 300 are respectively and independently disposed in two different cavities in the accommodating space 110, so that a mutual interference between the bone-conduction speaker 200 and the air-conduction speaker 300 can be effectively reduced, thereby effectively improving the sound quality of the earphone 1. The closed property may be understood as air tightness of the cavity space.

On the basis of the above, the communication hole 113 is provided between the first accommodating cavity 111 and the second accommodating cavity 112, and the bone-conduction speaker 200 is disposed at one side of the communication hole 113 to block the communication hole 113, which can ensure strong the air tightness of the second accommodating cavity 112 and enlarge a usable space of the first accommodating cavity 111 at the same time. Therefore, the assembly convenience of the air-conduction speaker 300 and the reliability of the structural arrangement can be effectively improved, and the acoustic cavity formed by the air-conduction speaker 300 in the second accommodating cavity 112 can also be simply and effectively enlarged. The sound output effect of the air-conduction speaker 300 can be improved, and the sound quality of the air-conduction speaker 300 can be enhanced. That is, when the volume of the acoustic cavity remains unchanged, the air-conduction speaker 300 may be disposed closer to a side of the bone-conduction speaker 200, so that the dimension of the speaker assembly 10 can be reduced and overall compactness of the speaker assembly 10 can be achieved.

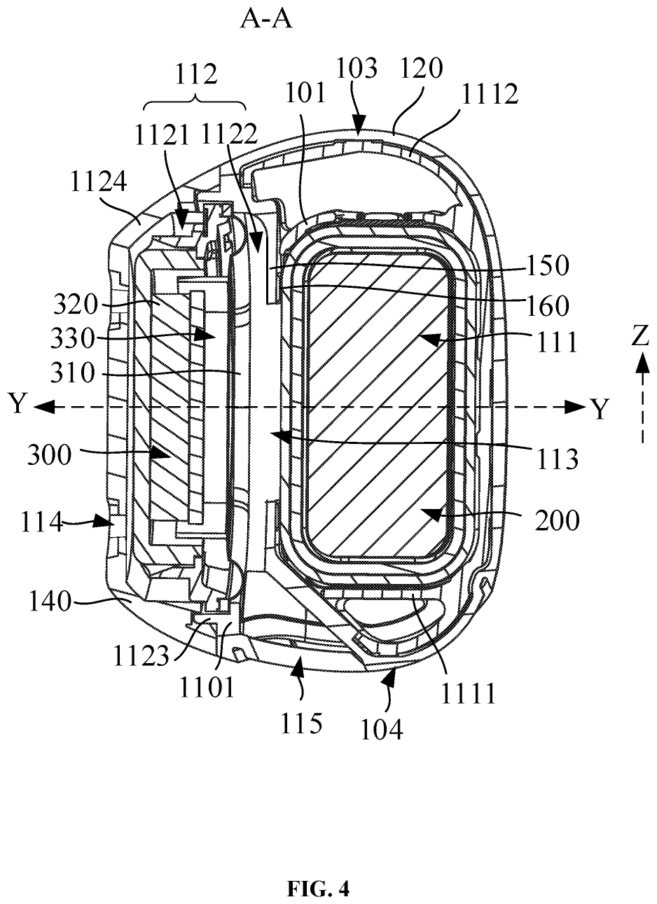

In some embodiments, as shown in FIG. 3a and FIG. 4, the housing assembly 100 may be provided with a sound outlet hole 114 and one or more pressure relief holes 115 connecting the second accommodating cavity 112 with the external environment, and the sound outlet hole 114 and the one or more pressure relief holes 115 may be arranged at intervals.

The air-conduction speaker 300 is disposed in the second accommodating cavity 112. The acoustic cavity (an external acoustic cavity) of the air-conduction speaker 300 may be formed in the second accommodating cavity 112.

The communication hole 113 is provided between the first accommodating cavity 111 and the second accommodating cavity 112, so that the second accommodating cavity 112 is in communication with the communication hole 113, and the bone-conduction speaker 200 blocks the communication hole 113 at a side of the communication hole 113 facing away from the second accommodating cavity 112. Therefore, the acoustic cavity in the second accommodating cavity 112 may be extended into the communication hole 113, thereby increasing the volume of the acoustic cavity, and better acoustic effects can be achieved. The sound outlet hole 114 is configured to guide sound waves generated by the air-conduction speaker 300 out of the speaker assembly 10 to propagate the sound waves into the ear canal of the user. The one or more pressure relief holes 115 are provided to connect the second accommodating cavity 112 with the external environment, so that air can freely flow in the second accommodating cavity 112 and the air-conduction speaker 300, thereby preventing the air in the second accommodating cavity 112 from generating damping on a vibration of the air-conduction speaker 300 and influencing the sound quality of the air-conduction speaker 300. Therefore, by providing the one or more pressure relief holes 115, better sound quality effects of the earphone 1 can be achieved.

The sound outlet hole 114 and the one or more pressure relief holes 115 are arranged at intervals, so that a mutual interference between the sound outlet hole 114 and the one or more pressure relief holes 115 is reduced, and an air pressure discharged from the one or more pressure relief holes 115 is difficult to affect sound waves transmitted in the sound outlet hole 114, thereby improving the sound quality effects of the earphone 1.

In some embodiments, as shown in FIG. 3a and FIG. 4, the one or more pressure relief holes 115 are connected to the second accommodating cavity 112, the communication hole 113 is in fluid communication with the second accommodating cavity 112, and the one or more pressure relief holes 115 may be in fluid communication with the communication hole 113 through the second accommodating cavity 112.

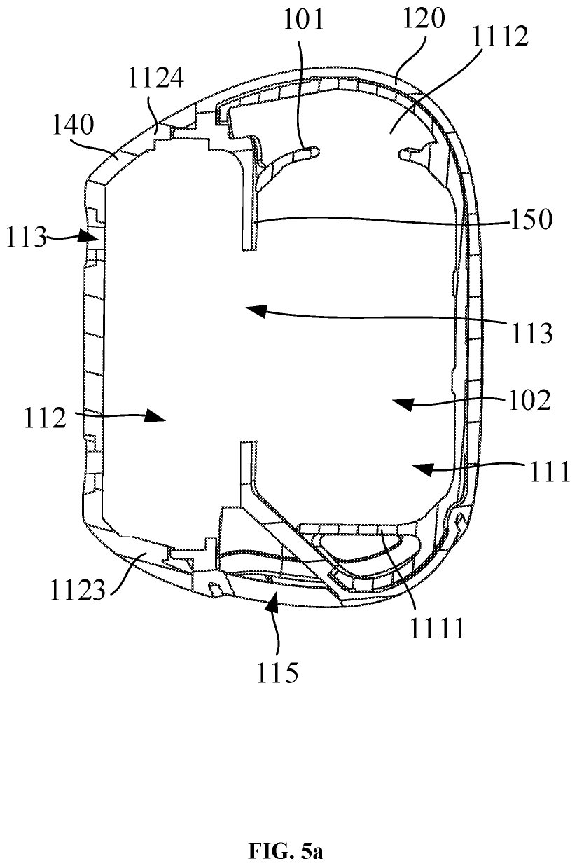

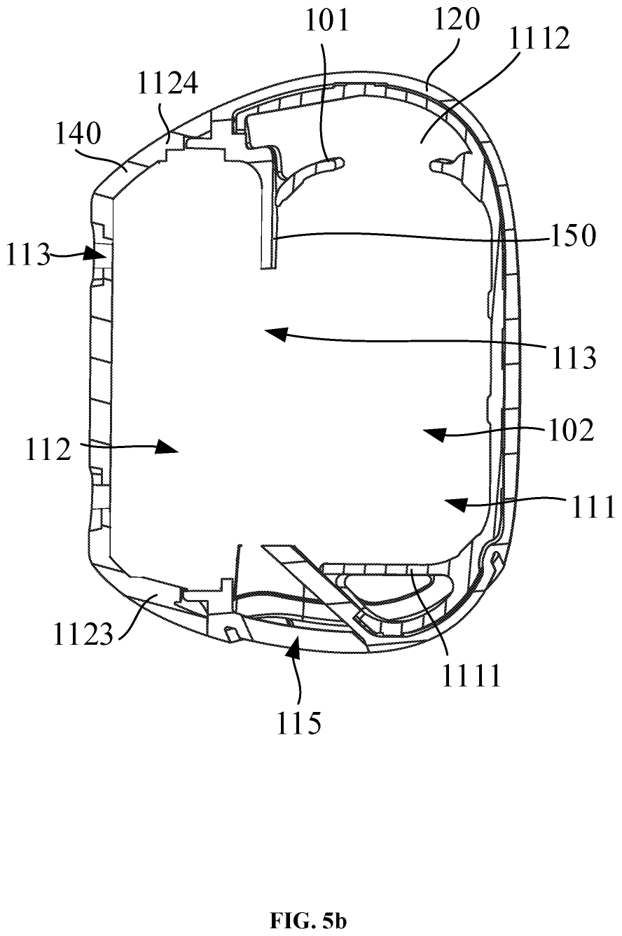

In another embodiment, as shown in FIG. 3b and FIG. 5b, the communication hole 113 may be directly in fluid communication with the one or more pressure relief holes 115, and the bone-conduction speaker 200 is also disposed on a side of the communication hole 113 facing the first accommodating cavity 111 to block the communication hole 113. Therefore, the air tightness of the first accommodating cavity 111 is ensured, the area of the air inlet end of each pressure relief hole 115 can be increased, the pressure relief effect of the pressure relief hole 115 can be improved, and the sound quality effects of the speaker assembly 10 can be enhanced.

In some embodiments, as shown in FIG. 3a and FIG. 4, the air-conduction speaker 300 may be configured to divide the second accommodating cavity 112 into a first sub-cavity 1121 and a second sub-cavity 1122 isolated from each other. The first sub-cavity 1121 is not in fluid communication with the second sub-cavity 1122. The sound outlet hole 114 may be in fluid communication with the first sub-cavity 1121, and the one or more pressure relief holes 115 may be in fluid communication with the second sub-cavity 1122. Furthermore, the communication hole 113 may be in fluid communication with the second sub-cavity 1122.

In some embodiments, as shown in FIG. 3a, the air-conduction speaker 300 includes a diaphragm 310 and a driving mechanism 320, and the driving mechanism 320 may be connected to the diaphragm 310. An internal acoustic cavity 330 between the diaphragm 310 and the driving mechanism 320 may be enclosed. A side of the diaphragm 310 facing away from the internal acoustic cavity 330 is the acoustic cavity, which is also the second sub-cavity 1122. The driving mechanism 320 is configured to be controlled by an electrical signal to drive the diaphragm 310 to generate a vibration, so that air in the internal acoustic cavity 330 of the air-conduction speaker 300 is caused to vibrate to generate an air-conduction sound wave. The air-conduction sound wave is transmitted through the first sub-cavity 1121, the second sub-cavity 1122 (i.e., the acoustic cavity), and the sound outlet hole 114 to the outside of the speaker assembly 10.

In this case, because of the presence of the communication hole 113, the volume of the second sub-cavity 1122 may be increased, i.e., the volume of the acoustic cavity may be increased, thereby enhancing the sound quality effects of the speaker assembly 10.

In some embodiments, when the earphone 1 operates, a part of the sound waves generated by the air-conduction speaker 300 through the air vibration principle may be transmitted out of the speaker assembly 10 through the first sub-cavity 1121 and the sound outlet hole 114. The one or more pressure relief holes 115 may connect the second sub-cavity 1122 with the external environment, so that air can freely flow between the external environment and the second sub-cavity 1122. If the second sub-cavity 1122 is closed, air in the second sub-cavity 1122 generates air damping on a vibration of the air-conduction speaker 300 when the air-conduction speaker 300 operates, thereby influencing the sound quality of the air-conduction speaker 300. Through the one or more pressure relief holes 115, an air pressure balance between the second sub-cavity 1122 and the external environment can be maintained, thereby reducing the influence on sound generation of the air-conduction speaker 300 and further reducing the influence on the sound quality effects of the earphone 1.

In some embodiments, the count of the one or more pressure relief holes 115 equals to 1 or exceeds 1. A plurality of pressure relief holes 115 are arranged at intervals. The plurality of pressure relief holes 115 can enhance the pressure relief effect, so that the earphone 1 has better sound quality. In some embodiments, at least two pressure relief holes 115 may connect with the external environment at positions on the housing assembly 100, and the positions are located on different sides of the housing assembly 100, thereby reducing the probability of enhanced interference of the plurality of pressure relief holes 115.

In some embodiments, as shown in FIG. 3a, FIG. 4, and FIG. 5a, the housing assembly 100 may include a first housing 120, a second housing 130, and a third housing 140. The second housing 130 and the first housing 120 may cooperate to form the first accommodating cavity 111 (schematically indicated on the first housing 120 in FIG. 4, but not meaning that the first accommodating cavity 111 is limited only to a portion of the first housing 120 shown in FIG. 4). The third housing 140 and the first housing 120 may cooperate to form the second accommodating cavity 112 (schematically indicated on the first housing 120 in FIG. 4, but not meaning that the second accommodating cavity 112 is limited only to a portion of the first housing 120 shown in FIG. 4). The communication hole 113 may be provided in the first housing 120. The third housing 140 may be provided with the sound outlet hole 114 connecting the second accommodating cavity 112 with the external environment, and the first housing 120 may be provided with the one or more pressure relief holes 115 connecting the second accommodating cavity 112 with the external environment. In some embodiments, the one or more pressure relief holes 115 may be provided on a side of the first housing 120 away from the third housing 140, so that the distance between each pressure relief hole 115 and the sound outlet hole 114 is relatively large.

By providing mutual abutment among the first housing 120, the second housing 130, and the third housing 140, the first accommodating cavity 111 and the second accommodating cavity 112 can be formed, whereby assembly and disassembly of the speaker assembly 10 can be facilitated, and compactness and stability of the structure of the speaker assembly 10 can be improved. By providing the sound outlet hole 114 in the third housing 140 and providing the one or more pressure relief holes 115 in the first housing 120, the distance between the sound outlet hole 114 and each pressure relief hole 115 can be increased, an mutual interference between sound waves respectively transmitted through the sound outlet hole 114 and the one or more pressure relief holes 115 can be reduced, and a probability of destructive interference of sound waves transmitted through the sound outlet hole 114 and the one or more pressure relief holes 115 in a near field can be reduced, so that the earphone 1 has better sound quality effects.

As shown in FIG. 2, the earphone 1 may include the wearing assembly 20 and the speaker assembly 10 as described above. The wearing assembly 20 may also be referred to as the ear hook 20. In some embodiments, the wearing assembly 20 may be connected to the first housing 120. By connecting the wearing assembly 20 to the first housing 120, a connection between the wearing assembly 20 and the speaker assembly 10 can be tightened, and a risk of detachment of the wearing assembly 20 from the speaker assembly 10 during use can be reduced. In some embodiments, the positions of the first housing 120 and the wearing assembly 20 correspond to the first accommodating cavity 111. In some embodiments, when the wearing assembly 20 is assembled on the first housing 120, the wearing assembly 20 may be directed toward the first accommodating cavity 111, so that the first housing 120 is closer to the first accommodating cavity 111 relative to a swinging position of the wearing assembly 20. When the bone-conduction speaker 200 generates a vibration on the first housing 120, the first housing 120 may swing with a larger amplitude and a faster swinging speed, thereby improving bone-conduction sound quality.

In some embodiments, as shown in FIG. 3a to FIG. 4, the housing assembly 100 may include a partition wall 150 that separates the first accommodating cavity 111 from the second accommodating cavity 112. The communication hole 113 may be provided on the partition wall 150. The bone-conduction speaker 200 may block the communication hole 113 on a side of the partition wall 150 facing the first accommodating cavity 111.

By using the partition wall 150 to separate the first accommodating cavity 111 from the second accommodating cavity 112, the bone-conduction speaker 200 may be further separated from the air-conduction speaker 300, thereby preventing air vibrations generated when the bone-conduction speaker 200 in the first accommodating cavity 111 vibrates from influencing the air-conduction speaker 300 to partially cancel air-conduction sound waves, preventing transmission of air-conduction sound waves from being influenced by the bone-conduction speaker 200, and preventing physical contact and collision between the bone-conduction speaker 200 and the air-conduction speaker 300, which causes a mutual damage. Because the partition wall 150 separates the first accommodating cavity 111 from the second accommodating cavity 112, assembly convenience of the bone-conduction speaker 200 and the air-conduction speaker 300 can also be improved. In some embodiments, when the bone-conduction speaker 200 blocks the communication hole 113 on a side of the partition wall 150 facing the first accommodating cavity 111, the communication hole 113 is in communication with the second accommodating cavity 112, so that a larger volume of space can be formed, thereby improving the air-conduction sound quality of the air-conduction speaker 300.

In some embodiments, as shown in FIG. 4, the bone-conduction speaker 200 may abut against the partition wall 150 to block the communication hole 113. In other words, a wall surface of the bone-conduction speaker 200 may directly or indirectly abut against the partition wall 150 to block the communication hole 113, thereby ensuring air tightness of the first accommodating cavity 111.

In other embodiments, a sealing member 160 may be provided between the bone-conduction speaker 200 and the partition wall 150. The sealing member 160 is arranged surrounding the communication hole 113. One side of the sealing member 160 tightly abuts against the partition wall 150 and surrounds the communication hole 113, and an opposite side of the sealing member 160 may tightly abut against a wall surface of the bone-conduction speaker 200, so that the bone-conduction speaker 200 may block the communication hole 113. By providing the sealing member 160 between the bone-conduction speaker 200 and the partition wall 150, air tightness of the first accommodating cavity 111 can be enhanced, thereby improving bone-conduction effects.

In some implementations, the sealing member 160 may include at least one of a sealing adhesive and a sealing ring. When the sealing member 160 is the sealing adhesive, the sealing adhesive may be dotted on the partition wall 150 around the communication hole 113 by dispensing, and then the bone-conduction speaker 200 is pressed against the sealing adhesive and the partition wall 150 to block the communication hole 113. The sealing ring also has good blocking performance, so that when the sealing ring is disposed between the partition wall 150 and the bone-conduction speaker 200, air tightness of the first accommodating cavity 111 can be improved. In other embodiments, the sealing member 160 may also be other components such as a blocking gasket or a soft filler, which are not enumerated in detail herein.

In some embodiments, as shown in FIG. 3a, FIG. 4, and FIG. 5a, the housing assembly 100 may be provided with a support wall 101 within the first accommodating cavity 111. The support wall 101 and the partition wall 150 together define a limiting space 102. The bone-conduction speaker 200 may be disposed within the limiting space 102 and abuts against the support wall 101. The support wall 101 and the partition wall 150 are configured to cooperatively limit the movement of the bone-conduction speaker 200 relative to the housing assembly 100 in a radial direction.

In some embodiments, a vibration direction of the bone-conduction speaker 200 relative to the housing assembly 100 may be an axial direction of the bone-conduction speaker 200, and a direction perpendicular to the axial direction of the bone-conduction speaker 200 is the radial direction of the bone-conduction speaker 200. The support wall 101 and the partition wall 150 may cooperate to limit the movement of the bone-conduction speaker 200 relative to the housing assembly 100 in any radial direction perpendicular to the axial direction of the bone-conduction speaker 200. The axial direction of the bone-conduction speaker 200 may be two directions along an X line shown in FIG. 3a, and the radial direction of the bone-conduction speaker 200 may be two directions along a Y line shown in FIG. 3a and FIG. 4, but the radial direction is not limited to the specific directions indicated by the Y line.

In some embodiments, one end of the support wall 101 may be connected to the first housing 120 or the second housing 130, and the other end of the support wall 101 extends toward the bone-conduction speaker 200. The support wall 101 is correspondingly adapted to an outer surface of the bone-conduction speaker 200, so that the support wall 101 is fitted to the bone-conduction speaker 200 in the radial direction of the bone-conduction speaker 200, such that the support wall 101 and the partition wall 150 may cooperate to limit the movement of the bone-conduction speaker 200 relative to the housing assembly 100 in the radial direction, thereby allowing the movement of the bone-conduction speaker 200 to the axial direction of the bone-conduction speaker 200 and also making an internal structure of the speaker assembly 10 more compact.

In some embodiments, as shown in FIG. 3a, the bone-conduction speaker 200 may have a first central axis X and may be configured to generate a vibration in a direction of the first central axis X. The bone-conduction speaker 200 may have a peripheral surface 201 arranged around the first central axis X, and the peripheral surface 201 blocks the communication hole 113. Two directions indicated by the first central axis X may also be the axial direction of the bone-conduction speaker 200, and the bone-conduction speaker 200 may generate the vibration in the direction of the first central axis X and transmit sounds to the user by a bone-conduction vibration manner.

In some embodiments, the peripheral surface 201 of the bone-conduction speaker 200 may abut against the support wall 101, and the support wall 101 and the partition wall 150 may cooperate to act on the peripheral surface 201 of the bone-conduction speaker 200 to limit the movement of the bone-conduction speaker 200 relative to the housing assembly 100 in the radial direction.

In some embodiments, as shown in FIG. 3a and FIG. 4, the air-conduction speaker 300 has a second central axis Y and is configured to generate a vibration in a direction of the second central axis Y

In some embodiments, the first central axis X and the second central axis Y may be perpendicular to each other, the direction indicated by the first central axis X may be the axial direction of the bone-conduction speaker 200, and the direction indicated by the second central axis Y may be the radial direction of the bone-conduction speaker 200 perpendicular to the axial direction.

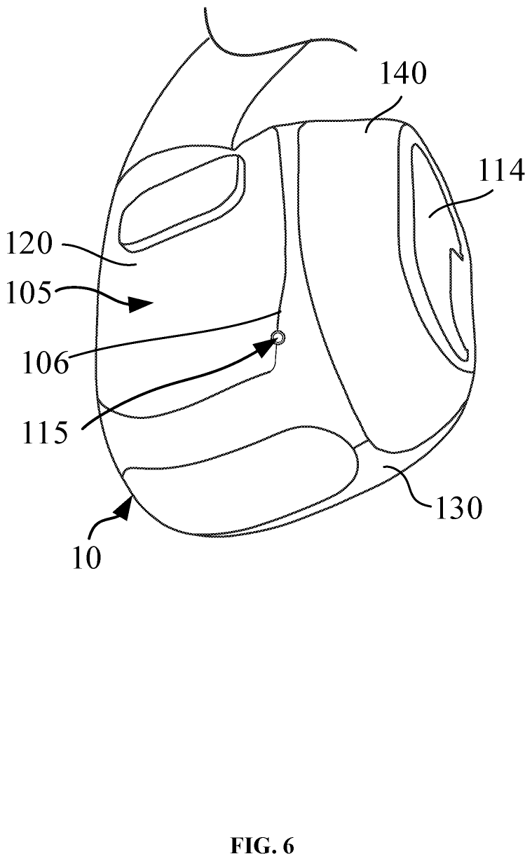

In some embodiments, as shown in FIG. 3a, FIG. 4, and FIG. 6, the housing assembly 100 may have a first side 103, a second side 104, and a third side 105. The first side 103 and the second side 104 are arranged opposite to each other in a direction perpendicular to the first central axis X and the second central axis Y, and the third side 105 is adjacent to the first side 103 and the second side 104. In some embodiments, the first central axis X or the second central axis Y may pass through the third side 105. At least one of the one or more pressure relief holes 115 may be provided on the first side 103 or the second side 104, and at least one of the one or more pressure relief holes 115 may be provided on the third side 105.

In some embodiments, the first central axis X may pass through the third side 105. The housing assembly 100 has a face-contacting side configured to transmit bone-conduction vibrations to a face of a user, and the third side 105 is arranged opposite to the face-contacting side. In other embodiments, the second central axis Y may pass through the third side 105. The third side 105 is arranged on the housing assembly 100 and opposite to a side where the sound outlet hole 114 is located.

By providing a plurality of pressure relief holes 115, a pressure relief area for pressure release from the second accommodating cavity 112 to the external environment can be enlarged, so that air can rapidly flow between the external environment and the second accommodating cavity 112. Air in the acoustic cavity inside the second accommodating cavity 112 can be further rapidly discharged to the external environment, thereby reducing damping effects on the operation of the air-conduction speaker 300 caused by limited air flow. In addition, failure of pressure relief in the second accommodating cavity 112 due to blockage of one pressure relief hole 115 can also be avoided, so that the influence on the vibration sound waves of the air-conduction speaker 300 can be reduced.

In some embodiments, different pressure relief holes 115 may be disposed on different sides of the housing assembly 100. For example, a pressure relief hole 115 may be disposed on the first side 103 or the second side 104 at a position corresponding to the second sub-cavity 1122. A pressure relief hole 115 may also be disposed on the third side 105 at the position corresponding to the second sub-cavity 1122, so that the pressure relief hole 115 may be in communication with the second sub-cavity 1122. In some embodiments of the present disclosure, a probability of interference, especially a probability of constructive interference, between sounds discharged from the plurality of pressure relief holes 115 can be reduced on the basis of an increased pressure relief area, so that sound quality effects are improved and the influence on sounds transmitted through the sound outlet hole 114 is further reduced.

In some embodiments, as shown in FIG. 6, the housing assembly 100 may be provided with a body ridge 106 protruding outward on the third side 105, and another one of the plurality of pressure relief holes 115 penetrates through the body ridge 106 to communicate with the external environment. When the earphone 1 is worn and used, an opening direction of the sound outlet hole 114 usually faces the ear canal of the user, and a side of the bone-conduction speaker 200 for bone conduction usually tightly abuts against skin beside the ear canal, so that the opening direction of the sound outlet hole 114 and the side for bone conduction intersect to form an acute angle, and the housing assembly 100 forms the body ridge 106 protruding outward on a side away from the skin of the human body.

In some embodiments, the body ridge 106 may be located on the first housing 120 at a position corresponding to the second accommodating cavity 112, so that a pressure relief hole 115 disposed on the body ridge 106 is in communication with the second accommodating cavity 112. By providing another pressure relief hole 115 on the body ridge 106, the pressure relief hole 115 is not easily covered when the earphone 1 is worn and used, thereby ensuring air circulation in the one or more pressure relief holes 115. In other embodiments, the body ridge 106 of the third side 105 may also be recessed inward toward an interior of the housing assembly 100.

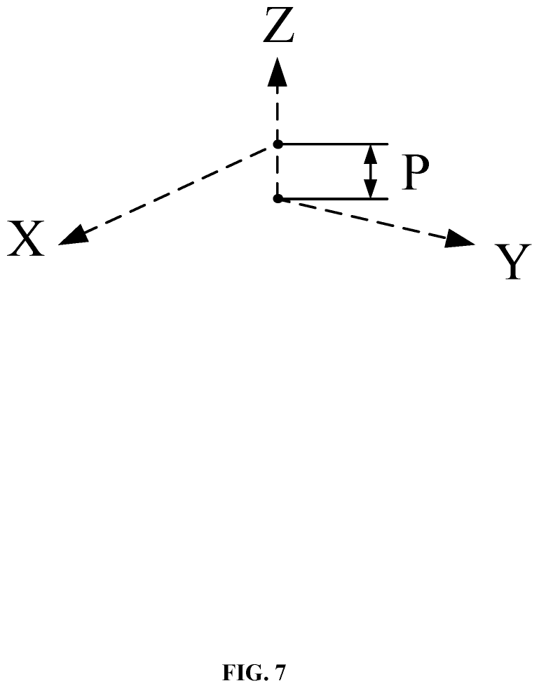

In some embodiments, as shown in FIG. 4, FIG. 5 a, and FIG. 7, in a direction Z perpendicular to the first central axis X and the second central axis Y, the first accommodating cavity 111 may have a first bottom wall 1111 and a second bottom wall 1112 arranged opposite to each other, and the second accommodating cavity 112 may have a third bottom wall 1123 and a fourth bottom wall 1124 arranged opposite to each other. The first bottom wall 1111 and the third bottom wall 1123 may be disposed adjacent, and the second bottom wall 1112 and the fourth bottom wall 1124 may be disposed adjacent. The direction Z has a positive direction from the first bottom wall 1111 toward the second bottom wall 1112 and a negative direction opposite to the positive direction. The positive direction is indicated by an arrow Z in FIG. 3a and FIG. 7.

In some embodiments, the peripheral surface 201 of the bone-conduction speaker 200 may abut against the first bottom wall 1111. The first bottom wall 1111, the support wall 101, and the partition wall 150 jointly enclose the limiting space 102, and the bone-conduction speaker 200 may be disposed within the limiting space 102 and abut against the support wall 101 and the first bottom wall 1111.

In the positive direction, a lowest position of the first bottom wall 1111 may be higher than a lowest position of the third bottom wall 1123.

In some embodiments, as shown in FIG. 4, the housing assembly 100 has a wall portion 1101 adjacent to the first accommodating cavity 111 in a direction perpendicular to the first central axis X and the second central axis Y, and one or more pressure relief holes 115 are provided on the wall portion 1101.

In some embodiments, the one or more pressure relief holes 115 are provided on the wall portion 1101 between the first bottom wall 1111 and the third bottom wall 1123, which can fully utilize a usable space inside the housing assembly 100 to improve a space utilization rate of the speaker assembly 10. Moreover, the lowest position of the first bottom wall 1111 may be higher than the lowest position of the third bottom wall 1123, such that the first bottom wall 1111 and the third bottom wall 1123 are staggered in height in the positive direction of the direction Z. The wall portion 1101 between the first bottom wall 1111 and the third bottom wall 1123 can thus have a larger space for providing the one or more pressure relief holes 115, so that the dimension of each pressure relief hole 115 can be increased, thereby enhancing the pressure relief effect.

In some embodiments, as shown in FIGS. 4 to 5a, the one or more pressure relief holes 115 may extend in a flared manner on the wall portion 1101 from the second accommodating space 110 toward an exterior of the housing assembly 100, and a portion of a hole wall of the one or more pressure relief holes 115 near the third bottom wall 1123 gradually inclines back towards a side where the third bottom wall 1123 is located. In this way, the dimension of the each pressure relief hole 115 may be further increased, pressure relief through the one or more pressure relief holes 115 may be facilitated, and the sound quality effect of the speaker assembly 10 may be enhanced.

In some embodiments, as shown in FIG. 3 a and FIG. 7, the first central axis X and the second central axis Y may be non-coplanar lines, and in the direction Z perpendicular to the first central axis X and the second central axis Y, the first central axis X and the second central axis Y may be offset from each other.

The bone-conduction speaker 200 vibrates in the direction of the first central axis X, and the air-conduction speaker 300 vibrates in the direction of the second central axis Y. Therefore, by configuring the first central axis X and the second central axis Y as the non-coplanar lines that are offset from each other, the mutual interference between the bone-conduction speaker 200 and the air-conduction speaker 300 during the vibration may be reduced, thereby improving an effect of generating and transmitting sound by the bone-conduction speaker 200 and the air-conduction speaker 300.

In some embodiments, as shown in FIG. 7, the first central axis X may be arranged higher than the second central axis Y in the positive direction, which facilitates arranging the lowest position of the first bottom wall 1111 higher than the lowest position of the third bottom wall 1123. Thus, forming a flared pressure relief hole 115 may be facilitated, so that the dimension of the flared pressure relief hole 115 can be set larger.

In some embodiments, as shown in FIG. 7, a distance P between the first central axis X and the second central axis Y may be in a range of 0.2 mm to 0.8 mm. The distance between the first central axis X and the second central axis Y may be as illustrated by the distance P in FIG. 7. For example, the distance P between the first central axis X and the second central axis Y may be 0.3 mm, 0.5 mm, or 0.7 mm.

In some embodiments, the first central axis X may be higher than the second central axis Y in the positive direction. By explicitly setting the distance between the first central axis X and the second central axis Y, the lowest position of the first bottom wall 1111 may be higher than the lowest position of the third bottom wall 1123, while the dimension of the speaker assembly 10 may be controlled to be reduced.

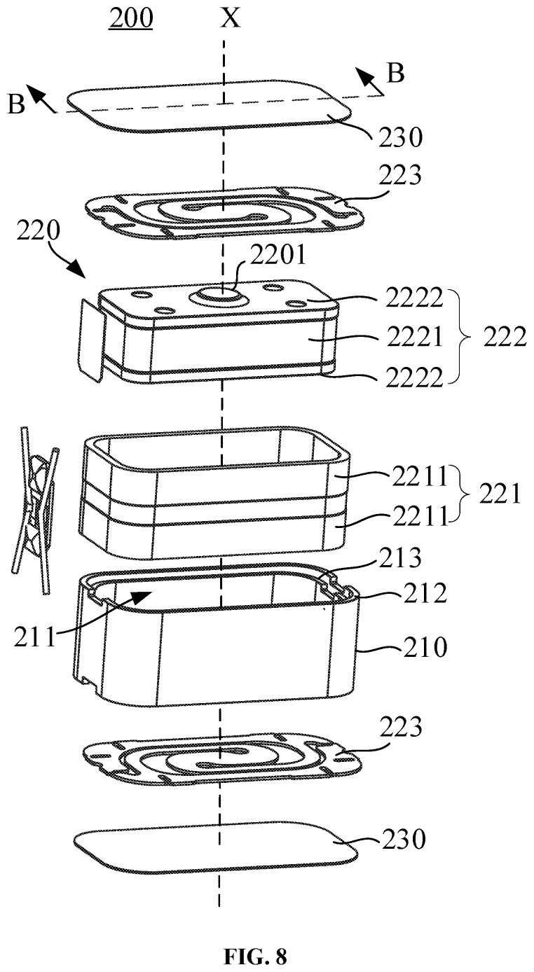

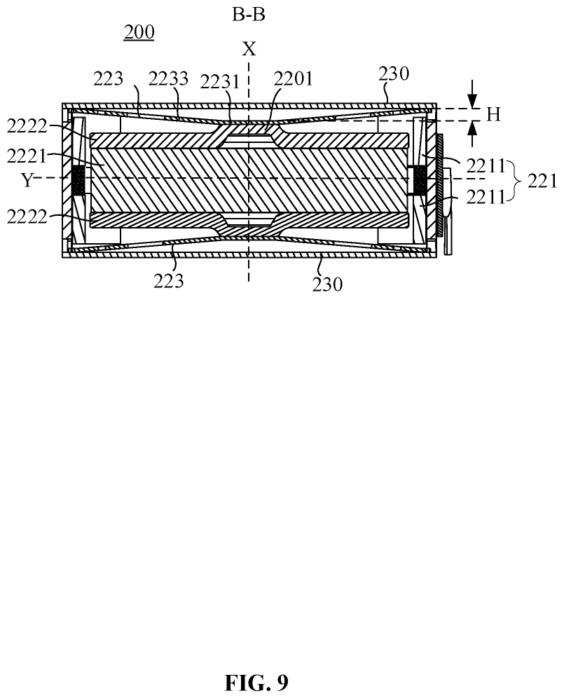

In some embodiments, as shown in FIGS. 8 and 9, the bone-conduction speaker 200 may include a cylindrical housing 210 extending along the first central axis X, a voice coil assembly 221, a magnet assembly 222, and a vibration transmission plate 223. The voice coil assembly 221 and the magnet assembly 222 may be disposed in a cylindrical space of the cylindrical housing 210. The vibration transmission plate 223 may be fixedly connected to one of the magnet assembly 222 and the voice coil assembly 221, and to the cylindrical housing 210. The other one of the magnet assembly 222 and the voice coil assembly 221 is fixedly connected to the cylindrical housing 210. The cylindrical housing 210 blocks the communication hole 113.

The magnet assembly 222 is configured to generate a vibration by interacting with the voice coil assembly 221 through its magnetic field when an electric current passes through the voice coil assembly 221, to convert an electric signal related to sounds into a vibration signal. The voice coil assembly 221 is configured to generate an electrical signal when the electric current passes through to interact with the magnetic field of the magnet assembly 222, thereby causing the magnet assembly 222 to generate the vibration. The cylindrical housing 210 may be a magnetic-conductive cover and is configured to constrain a direction of the magnetic field of the magnet assembly 222. The cylindrical housing 210 is further configured to contact the housing assembly 100, and when the voice coil assembly 221 generates a vibration, the voice coil assembly 221 may drive the cylindrical housing 210 to vibrate, so that the vibration signal is transmitted to the housing assembly 100 through the cylindrical housing 210. The vibration transmission plate 223 is configured to elastically connect the voice coil assembly 221 and the magnet assembly 222 to elastically constrain a relative movement of the voice coil assembly 221 and the magnet assembly 222 in the direction of the first central axis X.

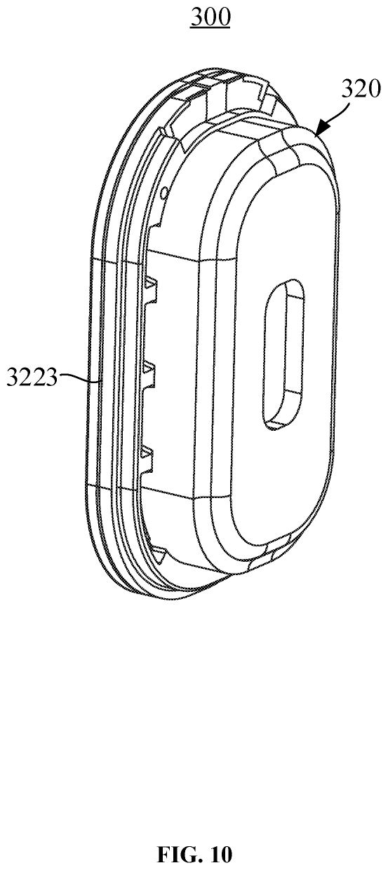

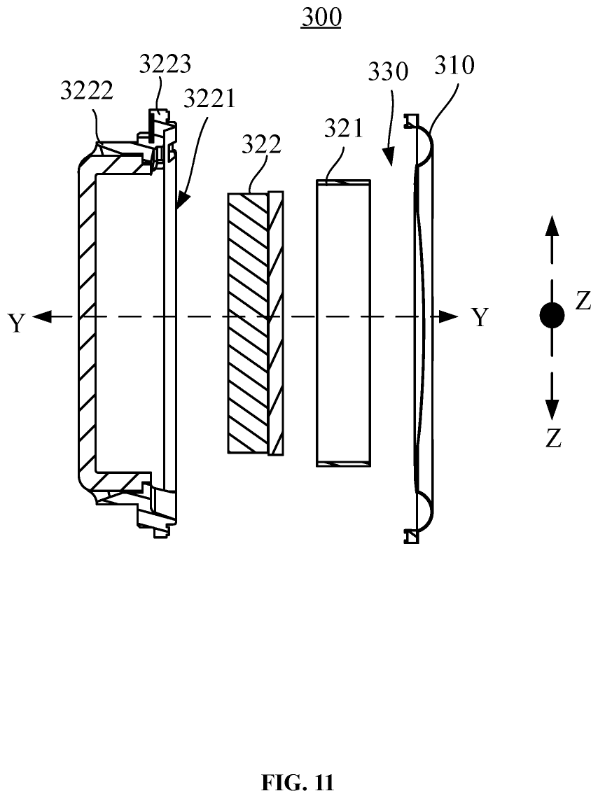

In some embodiments, as shown in FIGS. 10 to 11, the air-conduction speaker 300 may include a diaphragm 310 and a driving mechanism 320. The driving mechanism 320 may be connected to the diaphragm 310, and an internal acoustic cavity 330 may be enclosed between the diaphragm 310 and the driving mechanism 320. The driving mechanism 320 is configured to drive the diaphragm 310 to generate the vibration under control of the electrical signal, so that air in the internal acoustic cavity 330 of the air-conduction speaker 300 vibrates to generate a sound wave.

The air-conduction speaker 300 may be disposed in the second accommodating cavity 112 in various manners. For example, the internal acoustic cavity 330 may be in fluid communication with the second sub-cavity 1122 to communicate with the one or more pressure relief holes 115, or the internal acoustic cavity 330 may be in fluid communication with the first sub-cavity 1121.

In some embodiments, the diaphragm 310 may be located closer to the communication hole 113 than the driving mechanism 320, the diaphragm 310 may be arranged opposite to the communication hole 113 and face the second sub-cavity 1122, and the first sub-cavity 1121 may be in communication with the internal acoustic cavity 330.

When the driving mechanism 320 drives the diaphragm 310 to generate a vibration, the diaphragm 310 is located closer to the communication hole 113, i.e., closer to the bone-conduction speaker 200. On one hand, the diaphragm 310 has a relatively large radial dimension and the driving mechanism 320 has a relatively small radial dimension. By arranging the larger diaphragm 310 closer to the bone-conduction speaker 200 and the smaller driving mechanism 320 closer to an outer side, a volume of the housing assembly 100 near the outer side may be effectively reduced, so that the volume and the dimension of the speaker assembly 10 become more compact and reasonable, and a utilization rate of an internal space of the speaker assembly 10 is improved. On the other hand, because the diaphragm 310 is arranged opposite to the communication hole 113 and faces the second sub-cavity 1122, the volume of the second sub-cavity 1122 may be effectively increased, and air in the second sub-cavity 1122 may be effectively transmitted to the external environment through the one or more pressure relief holes 115, thereby improving the pressure relief effect.

In some embodiments, the diaphragm 310 may be located farther from the communication hole 113 than the driving mechanism 320, the diaphragm 310 may be disposed away from the communication hole 113 and face the first sub-cavity 1121, and the second sub-cavity 1122 may be in communication with the internal acoustic cavity 330.

By disposing the diaphragm 310 away from the communication hole 113 and facing the first sub-cavity 1121, a sound wave generated by the diaphragm 310 may be conveniently transmitted to the first sub-cavity 1121. Moreover, due to the presence of the communication hole 113 and the second sub-cavity 1122, the internal acoustic cavity 330 is equivalent to being enlarged, and pressure relief may be performed through the one or more pressure relief holes 115, thereby effectively improving the pressure relief effect.

In some embodiments, as shown in FIGS. 10 to 11, the driving mechanism 320 may include a voice coil 321 and a magnetic circuit assembly 322. The magnetic circuit assembly 322 may include a cover 3222 having an open end 3221 and an annular flange 3223 provided at the open end 3221 of the cover 3222 and protruding from an outer peripheral surface of the cover 3222. The magnetic circuit assembly 322 is configured to interact with the voice coil 321 to generate a vibration, and the voice coil 321 is configured to interact with a magnetic field of the magnetic circuit assembly 322 when an electric current passes through to drive the magnetic circuit assembly 322 to generate a vibration.

The edge of the diaphragm 310 may be fixed to the annular flange 3223. The voice coil 321 may be connected to a side of the diaphragm 310 facing the magnetic circuit assembly 322. The internal acoustic cavity 330 may be enclosed between the diaphragm 310 and the magnetic circuit assembly 322, and the diaphragm 310 may be located on a side of the cover 3222 that is away from the sound outlet hole 114 and face the communication hole 113. The first sub-cavity 1121 is in fluid communication with the internal acoustic cavity 330. By configuring the first sub-cavity 1121 to be in fluid communication with the internal acoustic cavity 330, a sound wave generated by the vibration of air in the internal acoustic cavity 330 may propagate through the first sub-cavity 1121 and the sound outlet hole 114 to the exterior of the speaker assembly 10.

In some embodiments, the annular flange 3223 may be provided on a side away from the sound outlet hole 114, and the diaphragm 310 may be disposed on the side away from the sound outlet hole 114. In this way, the diaphragm 310 and the annular flange 3223 may be located closer to the interior of the housing assembly 100, so that the diaphragm 310 and the annular flange 3223 of the air-conduction speaker 300 with relatively large radial dimensions are disposed away from the sound outlet hole 114, while smaller portions of the air-conduction speaker 300 are located closer to the sound outlet hole 114. Compared with a conventional structure in which the diaphragm 310 of the speaker has to face the sound outlet hole 114, a reverse arrangement of the air-conduction speaker 300 can effectively reduce the dimension of a portion of the housing assembly 100 near the sound outlet hole 114. Thus, from a middle region to a portion near the sound outlet hole 114, the dimension of the housing assembly 100 may be reduced, i.e., the radial dimension of the outer peripheral surface of the housing assembly 100 may gradually decrease. As a result, the structure becomes more compact, the space utilization rate of the housing assembly 100 is effectively improved, and an overall volume of the housing assembly 100 may be reduced. Moreover, the reverse arrangement can optimize a sound emission path and thereby improve the sound quality. In brief, by arranging the air-conduction speaker 300 in the reverse manner along the air-conduction vibration direction, a structural dimension of the housing assembly 100 can be effectively reduced.

In the speaker assembly 10, if positions of the sound outlet hole 114 and the one or more pressure relief holes 115 are relatively close to each other, sound waves respectively generated by the one or more pressure relief holes 115 and the sound outlet hole 114 may interfere with each other in a near field. Low-frequency sound waves transmitted from the sound outlet hole 114 are prone to be attenuated under out-of-phase interference from sound waves released by the one or more pressure relief holes 115 during pressure relief, thereby causing a sound cancellation phenomenon. More descriptions regarding the one or more pressure relief holes 115 and the sound outlet hole 114 may be found in other contents of the present disclosure (e.g., in the following embodiments).

The following provides an exemplary description of the earphone 1 according to another embodiment.

As described above, the housing assembly 100 may be provided with an accommodating space 110. The air-conduction speaker 300 is disposed in the accommodating space 110. The bone-conduction speaker 200 is disposed in the accommodating space 110.

In some embodiments, the bone-conduction speaker 200 has a first central axis X and is configured to generate a vibration in a direction of the first central axis X. The air-conduction speaker 300 has a second central axis Y and is configured to generate a vibration in a direction of the second central axis Y. In some embodiments, the voice coil and the diaphragm of the air-conduction speaker 300 generate a vibration in the direction of the second central axis Y.

The housing assembly 100 is further provided with the sound outlet hole 114 and the one or more pressure relief holes 115 communicating with the accommodating space 110. The sound outlet hole 114 and the one or more pressure relief holes 115 are respectively configured to transmit a part of the sound waves generated by the air-conduction speaker 300 to the external environment. The one or more pressure relief holes 115 and the sound outlet hole 114 may be respectively located on two opposite side surfaces of the housing assembly 100.

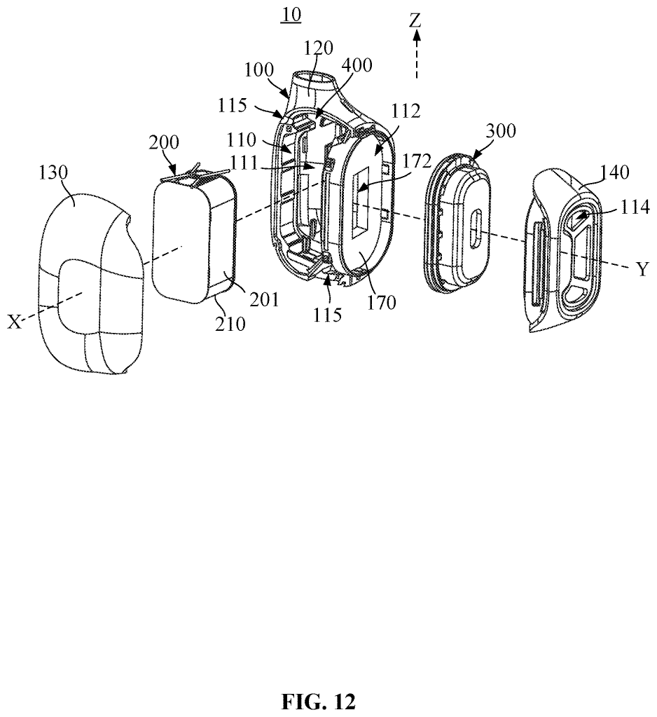

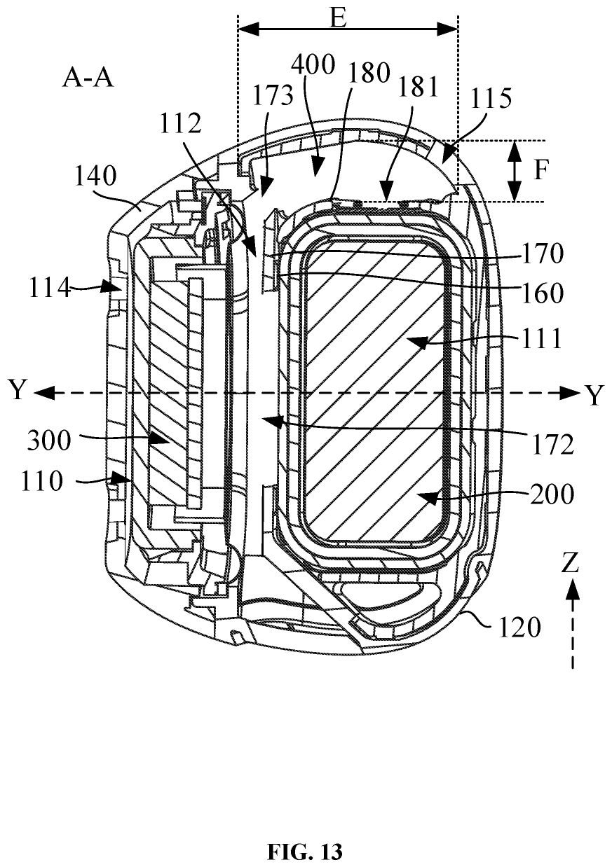

As shown in FIGS. 12 to 13, the housing assembly 100 may include the first housing 120, the second housing 130, and the third housing 140. The first housing 120, the second housing 130, and the third housing 140 may jointly enclose the accommodating space 110. In some embodiments, the second housing 130 may be connected to the first housing 120 in the direction of the first central axis X, and the third housing 140 may be connected to the second housing 130 in the direction of the second central axis Y. In some embodiments, the sound outlet hole 114 may be provided on the third housing 140, and the one or more pressure relief holes 115 may be provided on a portion of the first housing 120 away from the third housing 140, such that the sound outlet hole 114 and the one or more pressure relief holes 115 are respectively located on the two opposite side surfaces of the housing assembly 100.

By providing the sound outlet hole 114 and the one or more pressure relief holes 115 on two opposite side surfaces of the housing assembly 100, compared with providing the sound outlet hole 114 and the one or more pressure relief holes 115 on other adjacent side surfaces or the same side surface of the housing assembly 100, the distance between the sound outlet hole 114 and each pressure relief hole 115 may be increased. As a result, the mutual influence between the sound outlet hole 114 and the one or more pressure relief holes 115 may be reduced, and near-field destructive interference between the sound outlet hole 114 and the one or more pressure relief holes 115, which may weaken sound waves transmitted from the sound outlet hole 114, may be mitigated. Thus, a sound cancellation phenomenon between the sound outlet hole 114 and the one or more pressure relief holes 115 can be alleviated, a low-frequency effect of the speaker assembly 10 can be improved, and a sound quality effect of the earphone 1 can be enhanced.

In some embodiments, as shown in FIGS. 12 to 13, the speaker assembly 10 may be provided with a pressure relief channel 400 communicating with the one or more pressure relief holes 115. The sound outlet hole 114 may be in fluid communication with the accommodating space 110, and the pressure relief channel 400 is configured to guide a part of sound waves generated by the air-conduction speaker 300 in the accommodating space 110 to the one or more pressure relief holes 115.

By providing the pressure relief channel 400 in fluid communication with the accommodating space 110 and the one or more pressure relief holes 115, air in the accommodating space 110 to be pressure-relieved can be conveniently guided into the pressure relief channel 400 and further discharged through the one or more pressure relief holes 115. On one hand, the pressure relief path can be extended to improve the pressure relief effect. On the other hand, because the pressure relief channel 400 is in communication with the one or more pressure relief holes 115, sound waves to be pressure-relieved are less likely to affect operations of other components during a pressure relief process, thereby enhancing the sound quality effect of the speaker assembly 10. The provision of the pressure relief channel 400 may also enable pressure relief of the air-conduction speaker 300 to be accurately positioned, thereby reducing the mutual influence between the sound outlet hole 114 and the one or more pressure relief holes 115, while improving the flexibility of pressure relief of the air-conduction speaker 300.

In some embodiments, the pressure relief channel 400 and the accommodating space 110 may be isolated from each other, and the pressure relief channel 400 may be in fluid communication with the accommodating space 110. In some embodiments, the first housing 120 may be provided with the pressure relief channel 400, one end of the pressure relief channel 400 may be in fluid communication with the accommodating space 110, and another end of the pressure relief channel 400 may be formed as the one or more pressure relief holes 115. In some embodiments, the pressure relief channel 400 and the accommodating space 110 may be separated from each other, so that pressure relief may be performed independently while air to be pressure-relieved is separated from other components in the accommodating space 110, thereby minimizing potential interference with the components in the accommodating space 110. In some embodiments, since the first housing 120 is provided with the pressure relief channel 400, on one hand, a larger distance between the each pressure relief hole 115 and the sound outlet hole 114 may be achieved. On the other hand, no additional assembly of the pressure relief channel 400 is required during assembly of the first housing 120, the second housing 130, and the third housing 140, so that assembly efficiency is improved.

In some embodiments, as shown in FIGS. 12 to 13, the accommodating space 110 may include a first accommodating cavity 111 and a second accommodating cavity 112 isolated from each other. The bone-conduction speaker 200 is disposed in the first accommodating cavity 111, and the air-conduction speaker 300 is disposed in the second accommodating cavity 112. The sound outlet hole 114 is in communication with the second accommodating cavity 112, the pressure relief channel 400 is in communication with the second accommodating cavity 112 and is arranged at intervals from the first accommodating cavity 111, and the pressure relief channel 400 is in communication with both the second accommodating cavity 112 and the one or more pressure relief holes 115.

In some embodiments, the second housing 130 and the first housing 120 may be cooperatively connected to form the first accommodating cavity 111, and the third housing 140 and the first housing 120 may be cooperatively connected to form the second accommodating cavity 112.

Because the operating principles of the bone-conduction speaker 200 and the air-conduction speaker 300 are different, by isolating the first accommodating cavity 111, the second accommodating cavity 112, and the pressure relief channel 400 from each other, independence of the operation of the bone-conduction speaker 200 can be ensured, an influence of the operation of the air-conduction speaker 300 on the bone-conduction speaker 200 can be minimized, and the bone-conduction speaker 200 can also be protected to some extent. During the operation of the earphone 1, sound waves generated by the air-conduction speaker 300 based on the air vibration principle may propagate to the exterior of the speaker assembly 10 through the sound outlet hole 114 to be transmitted into the ear canal of the user. Therefore, by providing the second accommodating cavity 112 where the air-conduction speaker 300 is located to be in communication with the external environment through the one or more pressure relief holes 115, air in the second accommodating cavity 112 and the air-conduction speaker 300 may freely flow, thereby preventing air in the second accommodating cavity 112 from generating damping on the vibration of the air-conduction speaker 300 and affecting the sound quality effect of the air-conduction speaker 300.

In some embodiments, the first accommodating cavity 111 and the second accommodating cavity 112 may be isolated from each other. In some embodiments, an area of the connection between the first accommodating cavity 111 and the external environment may be smaller than an area of the connection between the second accommodating cavity 112 and the external environment and an area of the connection between the pressure relief channel 400 and the external environment. In other words, the airtightness of the first accommodating cavity 111 is stronger than airtightness of the second accommodating cavity 112 and the pressure relief channel 400. The airtightness may be understood as the airtight performance of a cavity space.

Because the bone-conduction speaker 200 requires an environment with strong airtightness to ensure a bone conduction effect, the bone-conduction speaker 200 and the air-conduction speaker 300 are independently disposed in two different cavities of the accommodating space 110 to effectively reduce the mutual interference between the bone-conduction speaker 200 and the air-conduction speaker 300. Moreover, by disposing the bone-conduction speaker 200 in the first accommodating cavity 111 with better airtightness, the sound quality effect of the bone-conduction speaker 200 can also be effectively improved.

In some embodiments, in the direction Z perpendicular to an arrangement direction of the first accommodating cavity 111 and the second accommodating cavity 112, the pressure relief channel 400 and the first accommodating cavity 111 are arranged at intervals. As shown in FIGS. 12 to 13, the arrangement direction of the first accommodating cavity 111 and the second accommodating cavity 112 may be consistent with the direction of the second central axis Y of the air-conduction speaker 300, corresponding to a Y line shown in FIGS. 12 and 13. The direction Z perpendicular to the arrangement direction of the first accommodating cavity 111 and the second accommodating cavity 112 corresponds to an arrow Z shown in FIGS. 12 and 13.

In some embodiments, a length component of an extension of the pressure relief channel 400 along the arrangement direction is greater than a length component of the extension of the pressure relief channel 400 along the direction Z. In this way, the pressure relief channel 400 may occupy a smaller dimension in the direction Z perpendicular to the arrangement direction, the dimension of the speaker assembly 10 in the direction Z may be reduced, a larger distance between the sound outlet hole 114 and the each pressure relief hole 115 may be enabled, and near-field mutual influence between the sound outlet hole 114 and the one or more pressure relief holes 115 may be reduced. The length component of the extension of the pressure relief channel 400 along the arrangement direction corresponds to a length E shown in FIG. 13, and the length component of the extension of the pressure relief channel 400 along the direction Z corresponds to a length F shown in FIG. 13, with E>F.

In some embodiments, as shown in FIGS. 12 to 13, the housing assembly 100 may have a first partition wall 170 between the first accommodating cavity 111 and the second accommodating cavity 112 and a second partition wall 180 between the pressure relief channel 400 and the first accommodating cavity 111. The first partition wall 170 may separate the second accommodating cavity 112 from the first accommodating cavity 111. The second partition wall 180 may separate the pressure relief channel 400 from the first accommodating cavity 111. In this way, the independent pressure relief channel 400 and the first accommodating cavity 111 may be formed. On one hand, the existence of the pressure relief channel 400 extends the pressure relief path, increases the dimension of the pressure relief space, improves the pressure relief effect, thereby enhancing the sound quality. On the other hand, operations of the air-conduction speaker 300 and the bone-conduction speaker 200 may not interfere with each other, the mutual influence between the two speakers may be reduced, and respective sound quality output effects may be ensured.

In some embodiments, one end of the second partition wall 180 may be connected to the first housing 120, and the opposite end of the second partition wall 180 is connected to the first partition wall 170, so that the pressure relief channel 400 and the first accommodating cavity 111 may be arranged at intervals in the direction Z.

In some embodiments, as shown in FIG. 13, the first partition wall 170 may further extend between the second accommodating cavity 112 and the pressure relief channel 400. The first partition wall 170 may be provided with a sound guide hole 173, and the sound guide hole 173 is in communication with the second accommodating cavity 112 and the pressure relief channel 400. The one or more pressure relief holes 115 are in fluid communication with the second accommodating cavity 112 through the pressure relief channel 400 and the sound guide hole 173. During operation of the earphone 1, a part of sound waves generated by the air-conduction speaker 300 to be pressure-relieved may sequentially propagate through the second accommodating cavity 112, the sound guide hole 173, the pressure relief channel 400, and the one or more pressure relief holes 115 to the exterior of the speaker assembly 10, thereby preventing air in the second accommodating cavity 112 from generating damping on the vibration of the air-conduction speaker 300 and affecting the sound quality effect of the air-conduction speaker 300.

In some embodiments, as shown in FIG. 13, the housing assembly 100 may be provided with a first communication hole 172 between the first accommodating cavity 111 and the second accommodating cavity 112, and the first communication hole 172 may be in fluid communication with the first accommodating cavity 111 and the second accommodating cavity 112. The bone-conduction speaker 200 may block the first communication hole 172 to isolate the first accommodating cavity 111 from the second accommodating cavity 112.

By providing the first communication hole 172 between the first accommodating cavity 111 and the second accommodating cavity 112 and blocking the first communication hole 172 on one side of the first communication hole 172 with the bone-conduction speaker 200, strong airtightness of the second accommodating cavity 112 may be ensured while a usable space of the first accommodating cavity 111 may be enlarged, thereby facilitating assembly convenience of the air-conduction speaker 300 and improving reliability of structural arrangement. Moreover, the volume of the acoustic cavity formed by the air-conduction speaker 300 in the second accommodating cavity 112 may be simply and effectively enlarged, so that the sound output effect of the air-conduction speaker 300 may be improved and the sound quality of the air-conduction speaker 300 may be enhanced. From another perspective, with the volume of the acoustic cavity maintained unchanged, the air-conduction speaker 300 may be disposed closer to a side of the bone-conduction speaker 200, so that the dimension of the speaker assembly 10 may be reduced, thereby achieving compactness of an overall dimension.

In some embodiments, as shown in FIG. 13, the housing assembly 100 may be provided with a second communication hole 181 between the first accommodating cavity 111 and the pressure relief channel 400, and the second communication hole 181 may be in communication with the first accommodating cavity 111 and the pressure relief channel 400. The bone-conduction speaker 200 may block the second communication hole 181 to isolate the first accommodating cavity 111 from the pressure relief channel 400.

Similarly, by providing the second communication hole 181 in communication with the first accommodating cavity 111 and the pressure relief channel 400 and disposing the bone-conduction speaker 200 to block the second communication hole 181, strong airtightness of the first accommodating cavity 111 may be ensured and an area of the pressure relief channel 400 may be increased, so that a larger space for pressure relief may be provided in the pressure relief channel 400 to improve the pressure relief effect. Alternatively, while the area of the pressure relief channel 400 is ensured, the pressure relief channel 400 may be disposed closer to the first accommodating cavity 111, so that the dimension of the speaker assembly 10 in the direction Z may be reduced.

In other embodiments, the pressure relief channel 400 may be configured in other forms. Other forms of the pressure relief channel 400 are exemplarily described below.

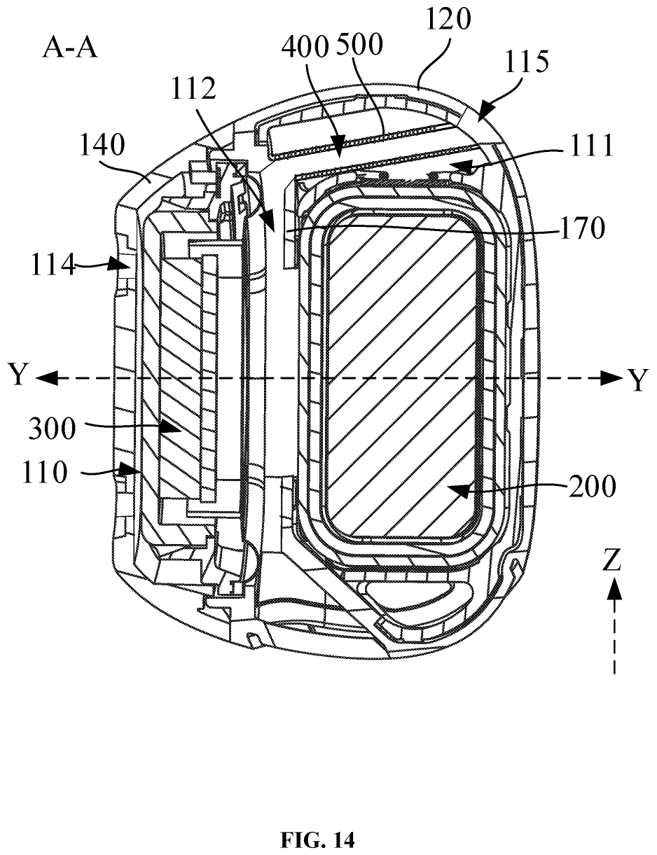

In some embodiments, as shown in FIG. 14, the speaker assembly 10 includes a channel tube 500 in which the pressure relief channel 400 is formed. The channel tube 500 is fixedly disposed in the housing assembly 100 and located within the first accommodating cavity 111. One end of the channel tube 500 is in communication with the second accommodating cavity 112, and the other end of the channel tube 500 is in communication with the one or more pressure relief holes 115.

In some embodiments, the first partition wall 170 may be disposed between the first accommodating cavity 111 and the second accommodating cavity 112, and the first partition wall 170 may separate the second accommodating cavity 112 from the first accommodating cavity 111. One end of the channel tube 500 may be connected to the first partition wall 170 and is in communication with the second accommodating cavity 112, and the other end of the channel tube 500 may be in communication with the one or more pressure relief holes 115 on the first housing 120, so that the second accommodating cavity 112 is in communication with the external environment. In some embodiments, the bone-conduction speaker 200 may be arranged at intervals with the channel tube 500 in the direction Z.

The channel tube 500 is disposed in the first accommodating cavity 111 and is isolated from the first accommodating cavity 111, and the channel tube 500 and the first accommodating cavity 111 are not in communication with each other. In some embodiments, a portion of the channel tube 500 in communication with the second accommodating cavity 112 is sealed relative to the first accommodating cavity 111, and a portion of the channel tube 500 in communication with the one or more pressure relief holes 115 is also sealed relative to the first accommodating cavity 111. In some embodiments, the channel tube 500 is sealingly connected to the first housing 120 within the first accommodating cavity 111, so that the channel tube 500 is not in communication with the first accommodating cavity 111. In this way, strong airtightness of the first accommodating cavity 111 may be ensured, thereby ensuring the bone conduction effect of the bone-conduction speaker 200.

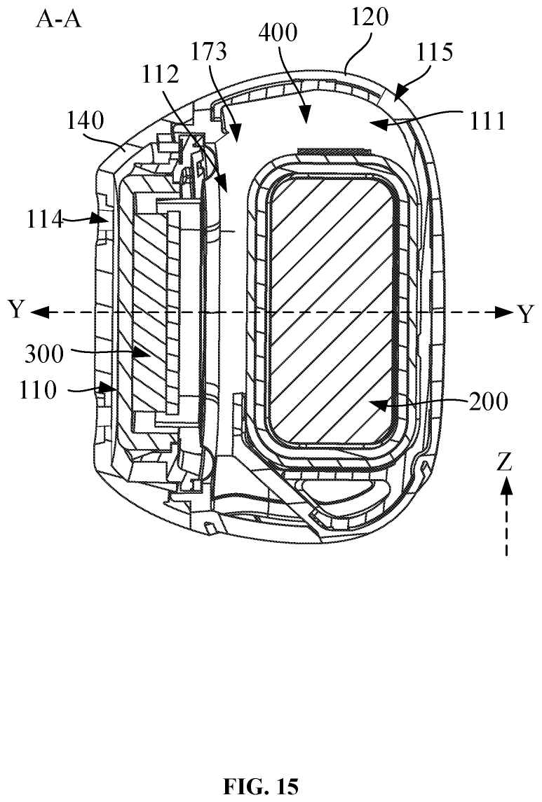

In other embodiments, as shown in FIG. 15, a portion of the accommodating space 110 may be formed as the pressure relief channel 400.

In some embodiments, the bone-conduction speaker 200 may be configured as a sealed structure, and its interior is isolated from the accommodating space 110. The pressure relief channel 400 may be formed by an enclosed arrangement between the bone-conduction speaker 200 and an inner wall of the accommodating space 110. Because the bone-conduction speaker 200 is a sealed structure, the bone-conduction speaker 200 may avoid the influence of moisture in the accommodating space 110 as much as possible, so that the bone-conduction speaker 200 can adapt to a non-airtight environment and generate a good bone conduction effect without requiring strong airtightness.

In some embodiments, as shown in FIG. 15, the accommodating space 110 may include the first accommodating cavity 111 and the second accommodating cavity 112 isolated from each other. The bone-conduction speaker 200 may be disposed in the first accommodating cavity 111, and the pressure relief channel 400 may be formed by an enclosed arrangement between the bone-conduction speaker 200 and an inner wall of the first accommodating cavity 111. The air-conduction speaker 300 may be disposed in the second accommodating cavity 112. The housing assembly 100 is provided with the sound guide hole 173 between the first accommodating cavity 111 and the second accommodating cavity 112, and the sound guide hole 173 is in communication with the first accommodating cavity 111 and the second accommodating cavity 112.

In some embodiments, the one or more pressure relief holes 115 are provided on the first housing 120 and are in communication with the first accommodating cavity 111. The sound waves generated by the air-conduction speaker 300 to be relieved may sequentially pass through the second accommodating cavity 112, the sound guide hole 173, the first accommodating cavity 111 (i.e., the pressure relief channel 400), and the one or more pressure relief holes 115, and may be discharged to the exterior of the speaker assembly 10.

In this way, by forming the pressure relief channel 400 through the enclosed arrangement of the bone-conduction speaker 200 and the inner wall of the first accommodating cavity 111, the internal structure of the first accommodating cavity 111 may be simplified, and the dimension of the first accommodating cavity 111 may be reduced, so that the structure of the speaker assembly 10 is more compact. Moreover, by forming the pressure relief channel 400 with the first accommodating cavity 111 and the bone-conduction speaker 200, space utilization of the first accommodating cavity 111 may be improved, so that the dimension of the pressure relief channel 400 may be increased by fully utilizing the space of the first accommodating cavity 111, the pressure relief effect may be improved, and the sound quality effect of the air-conduction speaker 300 may thereby be enhanced.

In some embodiments, as shown in FIGS. 8 to 9, the bone-conduction speaker 200 may include a cylindrical housing 210, a driving assembly 220, and two sealing plates 230. The cylindrical housing 210 may be fixedly connected to the housing assembly 100. The driving assembly 220 is disposed in the cylindrical housing 210, and the driving assembly 220 is configured to drive the cylindrical housing 210 to vibrate, thereby driving the housing assembly 100 to vibrate. The two sealing plates 230 may be disposed at two ends of the cylindrical housing 210 and block the cylindrical housing 210 to form a sealed structure.

In some embodiments, the driving assembly 220 is disposed between the two sealing plates 230, and the driving assembly 220 and the two sealing plates 230 are sequentially arranged in the direction of the first central axis X. The driving assembly 220 is configured to generate a vibration in the direction of the first central axis X in response to an electric signal, to drive the cylindrical housing 210 and to drive the housing assembly 100 to vibrate, so that a vibration signal is transmitted to the human body in contact with the housing assembly 100, thereby achieving a bone conduction function.

By providing the two sealing plates 230 to block the cylindrical housing 210, the sealed structure of the bone-conduction speaker 200 is achieved, so that an interference of external moisture and dust with the bone-conduction speaker 200 is reduced. Moreover, the bone-conduction speaker 200 has a more integrated and compact structure. In some embodiments, the sealing plate 230 may be configured as a magnetic-conductive plate to suppress magnetic leakage of the driving assembly 220 and enhance magnetic field strength in the cylindrical housing 210.

In some embodiments, as shown in FIGS. 8 to 9, the bone-conduction speaker 200 may further include the vibration transmission plate 223. The driving assembly 220 may further include the voice coil assembly 221 and the magnet assembly 222. The voice coil assembly 221 may be sleeved on the magnet assembly 222. The vibration transmission plate 223 may be fixedly connected to the cylindrical housing 210 and one of the voice coil assembly 221 and the magnet assembly 222, and the other one of the voice coil assembly 221 and the magnet assembly 222 may be fixedly connected to the cylindrical housing 210.

The magnet assembly 222 is configured to interact with the magnetic field of the voice coil assembly 221 when an electric current passes through the voice coil assembly 221, to generate a vibration and convert an electric signal related to sounds into a vibration signal. The voice coil assembly 221 is configured to interact with the magnetic field of the magnet assembly 222 when the electric current passes through, to generate a vibration. The cylindrical housing 210 is configured to constrain the direction of the magnetic field of the magnet assembly 222, and the cylindrical housing 210 is further configured to contact the housing assembly 100. When the voice coil assembly 221 vibrates, the voice coil assembly 221 may drive the cylindrical housing 210 to vibrate, so that the vibration signal is transmitted to the housing assembly 100 through the cylindrical housing 210. The vibration transmission plate 223 is configured to elastically connect the voice coil assembly 221 and the magnet assembly 222 to elastically constrain a relative movement of the voice coil assembly 221 and the magnet assembly 222 in the direction of the first central axis X.

The following embodiments exemplarily describe the sealed structure of the bone-conduction speaker 200 in further detail.

Referring to FIG. 3a, the bone-conduction speaker 200 is disposed in the accommodating space 110. The bone-conduction speaker 200 is connected to the housing assembly 100. In some embodiments, when the earphone 1 is in use, the housing assembly 100 may be in contact with the human body of the user, and the bone-conduction speaker 200 is configured to drive the housing assembly 100 to vibrate through a bone-conduction vibration to transmit sounds to the user.

In some embodiments, as shown in FIGS. 8 to 9, the bone-conduction speaker 200 may include the cylindrical housing 210, the driving assembly 220, and the two sealing plates 230. The cylindrical housing 210 may enclose an accommodating space 211. The driving assembly 220 may be disposed in the accommodating space 211 and connected to the cylindrical housing 210. The two sealing plates 230 may be respectively disposed at two ends of the cylindrical housing 210 and seal the accommodating space 211.

The driving assembly 220 may be configured to convert the electric signal into a vibration signal, so that when the bone-conduction speaker 200 is in use, the driving assembly 220 may generate the vibration and drive the cylindrical housing 210 to vibrate. The two sealing plates 230 close the two ends of the cylindrical housing 210, so that the accommodating space 211 in which the driving assembly 220 is located forms the sealed space, thereby limiting the driving assembly 220 and preventing the driving assembly 220 from falling out of the cylindrical housing 210. Moreover, by sealing the cylindrical housing 210 with the two sealing plates 230, dust, water droplets, and other impurities may be prevented from entering the accommodating space 211 and affecting the vibration of the driving assembly 220, so that a bone conduction effect of the bone-conduction speaker 200 is ensured, and a service life of the bone-conduction speaker 200 may also be prolonged. Furthermore, the bone-conduction speaker 200 has a more integrated and compact structure.

In some embodiments, the sealing plate 230 may be configured as the magnetic-conductive plate to suppress the magnetic leakage of the driving assembly 220 and enhance the magnetic field strength in the cylindrical housing 210. For example, the sealing plate 230 may be a steel plate. In some embodiments, the sealing plate 230 may also be a common metal plate.

In some embodiments, as shown in FIGS. 8 to 9, the bone-conduction speaker 200 may further include the vibration transmission plate 223, and the vibration transmission plate 223 is connected between the driving assembly 220 and the cylindrical housing 210. In an axis direction of the cylindrical housing 210, the vibration transmission plate 223 may be disposed between the driving assembly 220 and the sealing plate 230, and is disposed opposite to the sealing plate 230. In some embodiments, the axis of the cylindrical housing 210 may coincide with the first central axis X of the bone-conduction speaker 200, and the X arrow indicates the axis direction of the cylindrical housing 210 in FIGS. 8 and 9.

The vibration transmission plate 223 is configured to connect the driving assembly 220 to limit the driving assembly 220, and the driving assembly 220 may drive the vibration transmission plate 223 to drive the cylindrical housing 210 to vibrate during vibration. In some embodiments, in the axis direction of the cylindrical housing 210, the sealing plate 230, the vibration transmission plate 223, and the driving assembly 220 are sequentially arranged. The vibration direction of the bone-conduction speaker 200 may also be the axis direction of the cylindrical housing 210, i.e., the vibration direction of the driving assembly 220 is also the axis direction of the cylindrical housing 210. In this way, when the driving assembly 220 vibrates during operation, the sealing plate 230 and the vibration transmission plate 223 may directly provide a double limitation on the driving assembly 220 in the vibration direction of the driving assembly 220, and the sealing plate 230 may also limit the vibration transmission plate 223, to prevent an excessive deformation of the vibration transmission plate 223 during the operation of the driving assembly 220, thereby improving a service life of the vibration transmission plate 223.

In some embodiments, as shown in FIGS. 8 to 9, the two sealing plates 230 may be fixedly connected to two ends of the cylindrical housing 210, and a peripheral edge of the vibration transmission plate 223 is fixed to an inner wall of the cylindrical housing 210.

In some embodiments, as shown in FIGS. 8 to 9, at least one end of the cylindrical housing 210 may be configured in a stepped shape, to form a first bearing surface 212 and a second bearing surface 213 with a step difference in the axis direction, and the second bearing surface 213 may be closer to the axis of the cylindrical housing 210 than the first bearing surface 212. The sealing plate 230 is fixedly supported on the first bearing surface 212. The peripheral edge of the vibration transmission plate 223 is fixedly supported on the second bearing surface 213.

In some embodiments, the first bearing surface 212 may be flush with a surface of the vibration transmission plate 223 disposed away from the second bearing surface 213, so that when a sealing plate 230 is fixedly supported on the first bearing surface 212, the vibration transmission plate 223 may be pressed against the second bearing surface 213, thereby further fixing the vibration transmission plate 223 to the cylindrical housing 210. In this way, the structure of the bone-conduction speaker 200 may be more compact, and assembly and installation are facilitated.

The connection between the sealing plate 230 and the first bearing surface 212 may be configured as a sealed arrangement (for example, fixed and sealed by applying the sealing adhesive or by welding), and another sealing plate 230 disposed at the other end of the cylindrical housing 210 may also be configured as the sealed arrangement with the cylindrical housing 210, so that the cylindrical housing 210 forms the sealed structure.

In other embodiments, the vibration transmission plate 223 may be fixedly connected to one end of the cylindrical housing 210, and a sealing plate 230 is fixedly stacked on a side of the vibration transmission plate 223 disposed away from the driving assembly 220 and is arranged at intervals from the cylindrical housing 210.

In some embodiments, in the axial direction of the cylindrical housing 210, the sealing plate 230, the vibration transmission plate 223, and the cylindrical housing 210 are sequentially stacked. The peripheral edge of the vibration transmission plate 223 is fixedly connected to one end surface of the cylindrical housing 210, and the sealing plate 230 is fixedly connected to the vibration transmission plate 223, so that the sealing plate 230 is connected to the cylindrical housing 210 through the vibration transmission plate 223. The connection between the vibration transmission plate 223 and the cylindrical housing 210 and the connection between the sealing plate 230 and the vibration transmission plate 223 are both configured as sealed arrangements.

In other embodiments, the vibration transmission plate 223 and the sealing plate 230 may also be fixed to the cylindrical housing 210 in other manners. For example, the peripheral edge of the vibration transmission plate 223 may be directly connected to the inner wall of the cylindrical housing 210, and the sealing plate 230 may be fixedly supported on one end of the first bearing surface 212 covering the sealing plate 230. The present embodiment does not enumerate the details one by one.

In some embodiments, as shown in FIGS. 8 to 9, a count of the vibration transmission plates 223 may be two. The two vibration transmission plates 223 may be respectively fixedly connected to the cylindrical housing 210, and the two sealing plates 230 may be correspondingly disposed on sides of the two vibration transmission plates 223 that are disposed away from the driving assembly 220.

In some embodiments, the two vibration transmission plates 223 and the two sealing plates 230 may be sequentially arranged along the axis direction of the cylindrical housing 210. Moreover, the two vibration transmission plates 223 and the two sealing plates 230 may be respectively located on two sides of the driving assembly 220. The two vibration transmission plates 223 connect the driving assembly 220 and the cylindrical housing 210 to limit the driving assembly 220 on two sides of the driving assembly 220. The two sealing plates 230 may be respectively disposed on sides of the two vibration transmission plates 223 that are disposed away from the driving assembly 220 to protect the two vibration transmission plates 223 and seal the accommodating space 211 of the cylindrical housing 210.

By providing the two vibration transmission plates 223, the driving assembly 220 may drive the two vibration transmission plates 223 during the vibration to drive the cylindrical housing 210 to vibrate, thereby improving the bone conduction effect of the bone-conduction speaker 200 and enhancing sensitivity of the bone-conduction speaker 200. In addition, by limiting the driving assembly 220, the pressure caused by the vibration of the driving assembly 220 may be shared, thereby improving a service life of the vibration transmission plate 223 and further prolonging a service life of the bone-conduction speaker 200.

In other embodiments, the count of the vibration transmission plate 223 may be one. The vibration transmission plate 223 may be disposed on one side of the cylindrical housing 210 and connected to the driving assembly 220 to limit the driving assembly 220. The two sealing plates 230 may also be disposed on two sides of the cylindrical housing 210 and seal an accommodating space 211 of the cylindrical housing 210, and the vibration transmission plate 223 may be located between the two sealing plates 230 to be disposed within the accommodating space 211 of the cylindrical housing 210. In some embodiments, the sealing plate 230 on a side disposed away from the vibration transmission plate 223 may be integrally formed with the cylindrical housing 210 to form an integral structure, so as to improve airtightness of the accommodating space 211.

In some embodiments, as shown in FIGS. 8 to 9, the driving assembly 220 may further include the voice coil assembly 221 and the magnet assembly 222. One of the voice coil assembly 221 and the magnet assembly 222 surrounds the other one of the voice coil assembly 221 and the magnet assembly 222, and the one of the voice coil assembly 221 and the magnet assembly 222 is fixedly connected to the cylindrical housing 210. The vibration transmission plate 223 is fixedly connected to the other one of the voice coil assembly 221 and the magnet assembly 222 and to the cylindrical housing 210. The vibration transmission plate 223 and the sealing plate 230 are disposed opposite to each other in the axis direction, and the vibration transmission plate 223 is configured to elastically constrain the relative movement of the voice coil assembly 221 and the magnet assembly 222 along the axis direction of the cylindrical housing 210. The voice coil assembly 221 is configured to receive an electrical current and form a current loop when the electrical current passes through the voice coil assembly 221, and the magnet assembly 222 is configured to interact with the electrical current in the voice coil assembly 221 to generate a vibration in the axis direction. The magnet assembly 222 may directly or indirectly drive the cylindrical housing 210 to move during the vibration. The magnet assembly 222 and the voice coil assembly 221 perform a relative movement along the axis direction of the cylindrical housing 210.

For example, in the embodiments shown in FIGS. 8 and 9, one of the voice coil assembly 221 and the magnet assembly 222 may be the voice coil assembly 221, and the other one of the voice coil assembly 221 and the magnet assembly 222 may be the magnet assembly 222. In some embodiments, the voice coil assembly 221 is disposed on the inner wall of the cylindrical housing 210 and fixedly connected to the cylindrical housing 210, the voice coil assembly 221 is arranged surrounding the magnet assembly 222, the magnet assembly 222 is disposed in an accommodating space 211 of the cylindrical housing 210 and is arranged at intervals from the voice coil assembly 221, and the vibration transmission plate 223 is fixedly connected to the magnet assembly 222 and the cylindrical housing 210. The magnet assembly 222, the vibration transmission plate 223, and the sealing plate 230 are sequentially arranged along the axis direction of the cylindrical housing 210. When the magnet assembly 222 interacts with the voice coil assembly 221, the magnet assembly 222 drives the cylindrical housing 210 to vibrate through the vibration transmission plate 223.

In other embodiments, one of the voice coil assembly 221 and the magnet assembly 222 may be the magnet assembly 222, and the other one of the voice coil assembly 221 and the magnet assembly 222 may be the voice coil assembly 221. In some embodiments, the magnet assembly 222 may be fixedly attached to the inner wall of the cylindrical housing 210, and the magnet assembly 222 is arranged surrounding the voice coil assembly 221, while the voice coil assembly 221 is connected to the cylindrical housing 210 through the vibration transmission plate 223. When the magnet assembly 222 interacts with the voice coil assembly 221, the magnet assembly 222 may directly drive the cylindrical housing 210 to generate a vibration, so that the cylindrical housing 210 drives the housing assembly 100 to vibrate.

By elastically constraining the relative movement of the voice coil assembly 221 and the magnet assembly 222 through the vibration transmission plate 223, the magnet assembly 222 may always be maintained within the surrounding of the voice coil assembly 221, thereby maintaining the interaction between the magnetic field of the magnet assembly 222 and the current of the voice coil assembly 221 to sustain the vibration of the magnet assembly 222, and thus enabling the bone-conduction speaker 200 to achieve a bone conduction function for a long period of time.

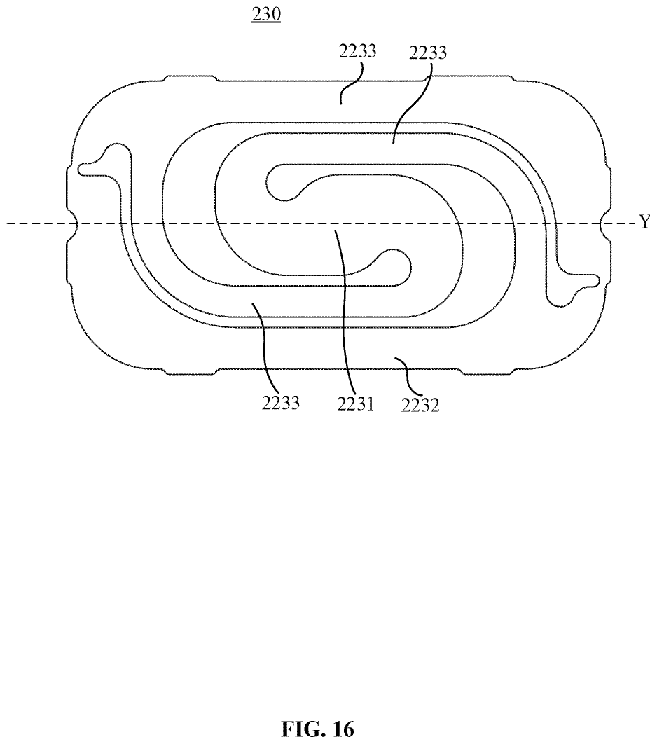

In some embodiments, as shown in FIG. 16, each vibration transmission plate 223 may be located between the other one of the voice coil assembly 221 and the magnet assembly 222 and a corresponding sealing plate 230. The sealing plate 230 is configured to rigidly constrain a deformation amplitude of the vibration transmission plate 223 in the axis direction, thereby rigidly constraining a relative movement range of the voice coil assembly 221 and the magnet assembly 222.

In some embodiments, during an interaction between the voice coil assembly 221 and the magnet assembly 222, the other one of the voice coil assembly 221 and the magnet assembly 222 may act on the vibration transmission plate 223 to cause the vibration transmission plate 223 to undergo an elastic deformation. Therefore, the sealing plate 230 is provided on a side of the vibration transmission plate 223 that is away from the voice coil assembly 221 and the magnet assembly 222 to rigidly constrain the deformation amplitude of the vibration transmission plate 223, so as to prevent the vibration transmission plate 223 from exceeding an elastic limit and transitioning from the elastic deformation to a plastic deformation during the deformation, thereby protecting the vibration transmission plate 223.

The sealing plate 230 may have a fixed position determined according to the relative movement range of the voice coil assembly 221 and the magnet assembly 222 and the elastic limit of the vibration transmission plate 223, so that the sealing plate 230 may constrain the relative movement range of the voice coil assembly 221 and the magnet assembly 222. In this way, the sealing plate 230 and the vibration transmission plate 223 may jointly constrain the relative movement range of the voice coil assembly 221 and the magnet assembly 222 within a maximum relative movement range, thereby protecting the vibration transmission plate 223, the voice coil assembly 221, and the magnet assembly 222, and also improving the vibration effect of the bone-conduction speaker 200.

In some embodiments, as shown in FIGS. 8 and 16, the vibration transmission plate 223 may include a central fixing portion 2231, an annular fixing portion 2232 surrounding an outer side of the central fixing portion 2231, and a connecting rod assembly 2233 connected between the central fixing portion 2231 and the annular fixing portion 2232. The annular fixing portion 2232 is connected to the cylindrical housing 210, and the central fixing portion 2231 is connected to the other one of the voice coil assembly 221 and the magnet assembly 222.

The connecting rod assembly 2233 may undergo an elastic deformation. When an electrical current passes through the voice coil assembly 221, the connecting rod assembly 2233 is configured to elastically constrain the other one of the voice coil assembly 221 and the magnet assembly 222. The elastic constraint may be understood such that the other one of the voice coil assembly 221 and the magnet assembly 222 performs a relative movement within a relative movement range allowed by the elastic deformation of the connecting rod assembly 2233. On one hand, the connecting rod assembly 2233 may limit the relative movement range between the voice coil assembly 221 and the magnet assembly 222 along the axis direction. On the other hand, after the voice coil assembly 221 and the magnet assembly 222 perform the relative movement, the connecting rod assembly 2233 may return the voice coil assembly 221 and the magnet assembly 222 to an original position through elastic recovery.

Since the vibration transmission plate 223 is provided with the connecting rod assembly 2233, the vibration transmission plate 223 has an excellent elastic deformation capability. However, the connecting rod assembly 2233 is in communication with the interior of the cylindrical housing 210, so that the connecting rod assembly 2233 cannot form a sealed space with the cylindrical housing 210. The sealed space may be formed between the vibration transmission plate 223 and the cylindrical housing 210 by blocking a hollow portion of the vibration transmission plate 223 with the sealing plate 230. In this way, magnetic circuit performance of the bone-conduction speaker 200 may be improved, and the sound quality effect may be enhanced.

In a natural state, the central fixing portion 2231 and the corresponding sealing plate 230 have a spacing in the axis direction. The natural state refers to a state in which no electrical current passes through the voice coil assembly 221, i.e., when the voice coil assembly 221 and the magnet assembly 222 are relatively stationary. When the voice coil assembly 221 and the magnet assembly 222 are relatively stationary, the spacing is provided between the central fixing portion 2231 and the corresponding sealing plate 230 in the axis direction, so that the other one of the voice coil assembly 221 and the magnet assembly 222 has a space for vibrating relative to the cylindrical housing 210 in the axis direction, thereby enabling the cylindrical housing 210 and the housing assembly 100 to perform the bone conduction to the human body of the user.

In some embodiments, in the natural state, the central fixing portion 2231 is closer to the other one of the voice coil assembly 221 and the magnet assembly 222 than the annular fixing portion 2232 in the axis direction. In the natural state, the vibration transmission plate 223 may have a certain pre-deformation, i.e., the connecting rod assembly 2233 of the vibration transmission plate 223 has a certain pre-deformation, which ensures that, in the natural state, the two vibration transmission plates 223 are respectively located on two sides of the magnet assembly 222 and act on the magnet assembly 222, thereby ensuring that the magnet assembly 222 is located at a central position of the cylindrical housing 210, and enabling the vibration of the magnet assembly 222 to be more stable in a subsequent vibration process.

In embodiments of the present disclosure, the sealing plate 230 may be a flat plate, a concave plate recessed toward the magnet assembly 222 at a middle portion relative to an edge portion, or a convex plate protruding away from the magnet assembly 222 at the middle portion relative to the edge portion.

In some embodiments, the distance between the central fixing portion 2231 and the corresponding sealing plate 230 is in a range of 0.005 mm to 0.8 mm.

By defining a distance between the central fixing portion 2231 and the corresponding sealing plate 230, the driving assembly 220 may drive the central fixing portion 2231 to vibrate within the distance, thereby driving the cylindrical housing 210 to vibrate.

In some embodiments, the distance between the central fixing portion 2231 and the corresponding sealing plate 230 may be a distance between a central point of the central fixing portion 2231 and a central point of the sealing plate 230. For example, the distance between the central fixing portion 2231 and the corresponding sealing plate 230 may be a distance H illustrated in FIG. 9. In some embodiments, the distance between the central point of the central fixing portion 2231 and the central point of the sealing plate 230 may be 0.2 mm, 0.5 mm, or 0.7 mm. By setting the distance between the central fixing portion 2231 and the corresponding sealing plate 230, the sealing plate 230 may limit vibrations of the central fixing portion 2231 and the driving assembly 220 accordingly, to prevent an excessive vibration amplitude of the driving assembly 220 from causing a deformation of the connecting rod assembly 2233 to exceed a bearing range and be damaged.

As shown in FIGS. 8 and 9, the magnet assembly 222 may further include a magnet 2221 and two magnetic conducting plates 2222. The two magnetic conducting plates 2222 are respectively disposed on two opposite sides of the magnet 2221 in the axis direction. Each magnetic conducting plate 2222 has a protruding portion 2201 protruding toward the central fixing portion 2231, and the protruding portion 2201 is fixedly connected to the central fixing portion 2231.

The magnetic conducting plate 2222 is configured to constrain a direction of a magnetic field of the magnet 2221 on two opposite end surfaces of the magnet 2221 in the axis direction to enhance an interaction effect between the magnet 2221 and the voice coil 2211.

The two protruding portions 2201 of the two magnetic conducting plates 2222 respectively protrude toward the central fixing portions 2231 of the two vibration transmission plates 223 opposite to the two magnetic conducting plates 2222, that is, the two protruding portions 2201 are oriented in opposite directions. By fixedly connecting the protruding portion 2201 with the central fixing portion 2231, the two magnetic conducting plates 2222 and the two vibration transmission plates 223 can be stably fixedly connected. In addition, connection portions between the magnetic conducting plates 2222 and the vibration transmission plates 223 do not excessively occupy a space of the connecting rod assembly 2233, so that the connecting rod assembly 2233 has a sufficient region for elastic deformation, thereby providing a sufficient deformation space and resulting in better elasticity of the vibration transmission plate 223.

In some embodiments, as shown in FIGS. 8 and 9, the voice coil assembly 221 may further include two sets of voice coils 2211 that are arranged at intervals in the axis direction. The cylindrical housing 210 is wound around an outer periphery of the two sets of voice coils 2211. Projections of the two magnetic conducting plates 2222 in the radial direction of the bone-conduction speaker 200 are at least partially overlapped with the two sets of voice coils 2211. The two sets of voice coils 2211 have opposite energizing directions.

The radial direction of the bone-conduction speaker 200 is illustrated by an arrow Y in FIG. 9. By arranging the projections of the two magnetic conducting plates 2222 in the radial direction of the bone-conduction speaker 200 to be at least partially overlapped with the two sets of voice coils 2211, the interaction between the two magnetic conducting plates 2222 and the magnet 2221 with the two sets of voice coils 2211 can be enhanced, so that the magnet assembly 222 becomes more sensitive. Furthermore, the two sets of voice coils 2211 have opposite energizing directions to ensure that the two sets of voice coils 2211 are subjected to forces in the same direction under an interaction with the same magnet 2221, so that the magnet 2221 is able to move in one direction under an action of the two sets of voice coils 2211 and the magnetic field, and the magnet 2221 may generate a vibration in the axis direction by changing current directions of the two sets of voice coils 2211.

In some embodiments, the accommodating space 211 is filled with a magnetic fluid, and the magnetic fluid occupies at least a portion of the accommodating space 211.

The magnetic fluid, also referred to as a magnetic liquid, a ferromagnetic fluid, or a ferrofluid, has fluidity of a liquid and magnetism of a solid magnetic material. The magnetic fluid has better magnetic conductivity compared with air, and is able to enhance the magnetic field effect of the magnet assembly 222, so that the vibration of the magnet assembly 222 becomes more sensitive. In addition, the presence of the magnetic fluid can reduce a resistance to the relative movement between the voice coil assembly 221 and the magnet assembly 222, thereby enhancing the vibration effect, effectively improving the sound quality, enhancing the bone-conduction effect of the bone-conduction speaker 200, and improving the sound quality effect of the speaker assembly 10.

In some embodiments, the magnetic fluid may not fill the accommodating space 211. In this way, the fluid resistance can be reduced, and the bone-conduction effect of the bone-conduction speaker 200 can be improved.

In some embodiments, since the bone-conduction speaker 200 generates the vibration along an axis of the bone-conduction speaker 200, the housing assembly 100 is driven to vibrate, and the air-conduction speaker 300 together with the housing assembly 100 constitutes a vibration load. In related technologies, the air-conduction speaker 300 is typically disposed at a side of the axis of the bone-conduction speaker 200 (for example, the air-conduction speaker 300 is often disposed in a radial direction perpendicular to the axis of the bone-conduction speaker 200). In this case, a mass of the air-conduction speaker 300 causes a bias to the vibration of the bone-conduction speaker 200, so that the speaker assembly 10 generates two torques in different directions, thereby weakening the vibration of the bone-conduction speaker 200 along the axis and reducing the bone-conduction component volume of the earphone 1.

To address the foregoing problem, the following embodiments provide exemplary descriptions regarding positions and structures of the speaker assembly 10 in connection with the bone-conduction speaker 200 and the air-conduction speaker 300.

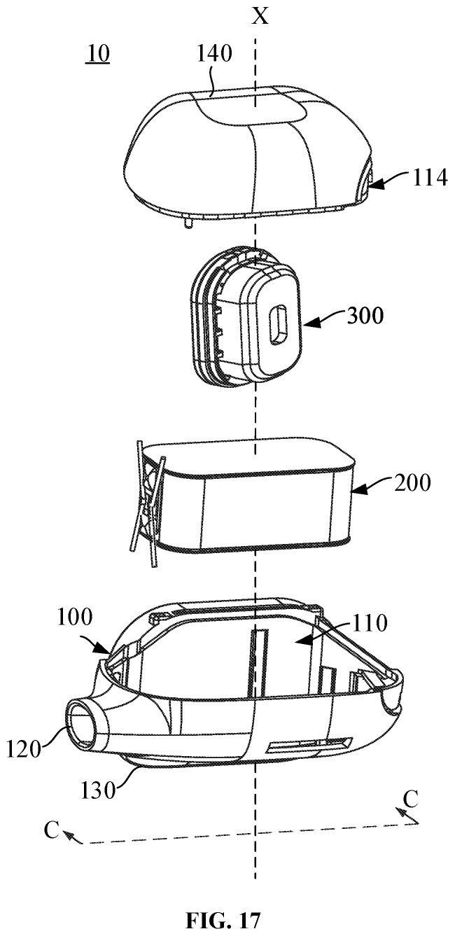

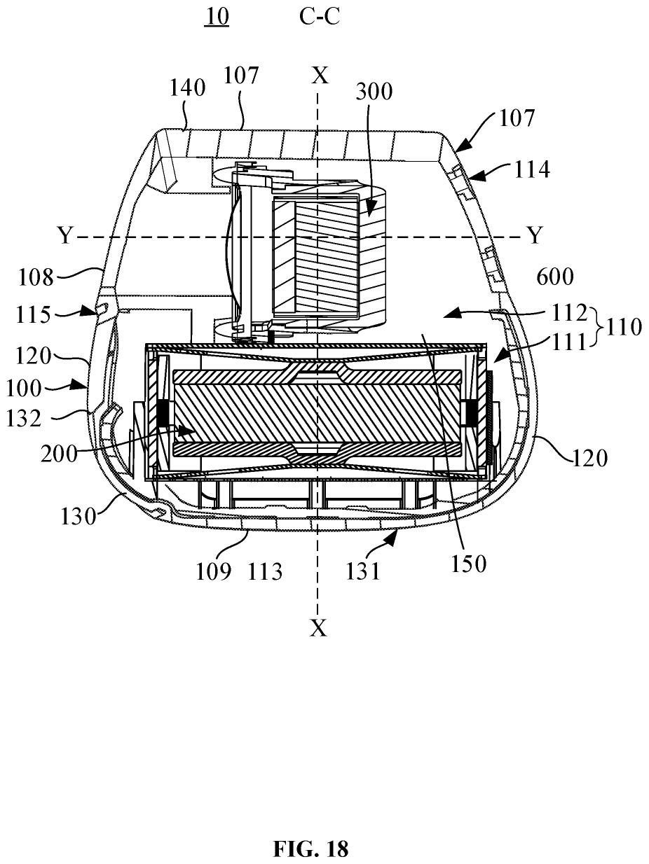

As shown in FIG. 17 and FIG. 18, as described above, a bone-conduction core module 200 and an air-conduction core module 300 are disposed in the housing assembly 100. The bone-conduction core module 200, also referred to as the bone-conduction speaker 200, is configured to transmit sounds to the user through the bone-conduction vibration. The air-conduction core module 300, also referred to as the air-conduction speaker 300, is configured to transmit sounds to the ear canal of the user through an air-vibration principle.

In some embodiments, the housing assembly 100 may be provided with the accommodating space 110. The bone-conduction core module 200 may be disposed in the accommodating space 110 and generate a vibration in a first vibration direction. The air-conduction core module 300 is disposed in the accommodating space 110 and arranged opposite to the bone-conduction core module 200 in the first vibration direction. In some embodiments, the air-conduction core module 300 and the bone-conduction core module 200 being arranged opposite to each other refers to a projection of the air-conduction core module 300 and a projection of the bone-conduction core module 200 having an overlapping region on a reference horizontal plane perpendicular to the first vibration direction.

The first vibration direction of the bone-conduction core module 200 may be consistent with a central axis direction of the bone-conduction core module 200, both as indicated by an arrow X in FIG. 18.

By providing the air-conduction core module 300 in the first vibration direction of the bone-conduction core module 200, the mass of the air-conduction core module 300 is more concentrated on the axis of the bone-conduction core module 200. When the bone-conduction core module 200 generates the vibration in the first vibration direction, a bias effect of the air-conduction core module 300 on the vibration of the bone-conduction core module 200 is reduced, so that the bone-conduction core module 200 can more effectively drive the housing assembly 100 to generate the vibration in the first vibration direction. As a result, the sound quality produced by the vibration of the bone-conduction core module 200 is more pure and conforms to acoustic design principles. In this way, an influence of the mass of the air-conduction core module 300 on the vibration effect of the bone-conduction core module 200 is reduced, so that the bone-conduction core module 200 achieves an improved bone-conduction effect, thereby enhancing the sound quality of the bone-conduction component of the earphone 1.

In some embodiments, the air-conduction core module 300 may generate the vibration in a second vibration direction. The angle between the first vibration direction and the second vibration direction is in a range of 70° to 100°, or 80° to 90°.

By arranging the first vibration direction and the second vibration direction to be different and intersect with each other, an interference between the air-conduction core module 300 and the bone-conduction core module 200 can be reduced, so that the air-conduction core module 300 achieves an improved sound output effect, and the bone-conduction core module 200 achieves a favorable bone-conduction effect.

The angle between the first vibration direction and the second vibration direction may be 75°, 85°, or 95°. For example, in some embodiments, the first vibration direction and the second vibration direction may be perpendicular to each other, such that the angle between the first vibration direction and the second vibration direction is 90°. The second vibration direction may be an axial direction of the air-conduction core module 300, as indicated by an arrow Y in FIG. 18.

In this way, the interference between the air-conduction core module 300 and the bone-conduction core module 200 can be greatly reduced, so that the vibration of the air-conduction core module 300 and the vibration of the bone-conduction core module 200 are less likely to be affected by each other, thereby improving the sound quality of the earphone 1.

In some embodiments, as shown in FIGS. 17 to 18, the housing assembly 100 may be provided with a first side surface 107, a second side surface 108, and a vibration transmission surface 109 (i.e., the face-contacting side mentioned above). The first side surface 107, the second side surface 108, and the vibration transmission surface 109 are not coplanar with each other. The first side surface 107 and the second side surface 108 are arranged at intervals in the direction perpendicular to the first vibration direction. The housing assembly 100 may be provided with the sound outlet hole 114 that penetrates through the first side surface 107 and is in communication with the accommodating space 110 and the one or more pressure relief holes 115 that penetrates through the second side surface 108 and is in communication with the accommodating space 110.

The sound outlet hole 114 and the one or more pressure relief holes 115 are respectively configured to conduct at least a part of sound waves generated by the air-conduction core module 300 to the external environment. The sound outlet hole 114 is generally disposed facing or near an ear of the user, so that the portion of the sound waves generated by the air-conduction core module 300 is conducted into the ear of the user, while the one or more pressure relief holes 115 are configured to release air in the accommodating space 110 that causes damping on the vibration of the air-conduction speaker 300, so that the accommodating space 110 achieves an air pressure balance and an influence on the vibration effect of the air-conduction core module 300 is reduced.

By respectively providing the sound outlet hole 114 and the one or more pressure relief holes 115 on the first side surface 107 and the second side surface that are arranged opposite to each other, a distance between the sound outlet hole 114 and the each pressure relief hole 115 can be relatively increased, thereby reducing the interaction, especially the destructive interference, between the portion of the sound waves released through the one or more pressure relief holes 115 and the sound waves conducted through the sound outlet hole 114, and thus improving the sound quality of sound conducted through the sound outlet hole 114. In other embodiments, positions where the sound outlet hole 114 and the one or more pressure relief holes 115 are provided on the housing assembly 100 may be interchanged, depending on a specific position of the human ear.

In some embodiments, the vibration transmission surface 109 may be perpendicular to the first vibration direction, and the bone-conduction core module 200 transmits vibrations outward through the vibration transmission surface 109. In this way, the one or more pressure relief holes 115, the sound outlet hole 114, and the vibration transmission surface 109 are not coplanar with each other, so that the sound waves conducted through the sound outlet hole 114, the sound waves released through the one or more pressure relief holes 115, and the vibrations on the vibration transmission surface 109 are not prone to interfere with each other, thereby improving the sound quality of the speaker assembly 10.

In some embodiments, as shown in FIG. 18, the air-conduction core module 300 may be superposed on the bone-conduction core module 200 in the first vibration direction. In other words, the air-conduction core module 300 and the bone-conduction core module 200 are stacked in the first vibration direction. In some embodiments, the air-conduction core module 300 may be fixedly connected to the bone-conduction core module 200.

By fixing the air-conduction core module 300 to the bone-conduction core module 200 in the first vibration direction, the bone-conduction core module 200 is able to conveniently drive the air-conduction core module 300 to vibrate, thereby reducing an influence of a counterweight effect of the air-conduction core module 300 on the vibrations of the bone-conduction core module 200, and ensuring the bone conduction effect of the speaker assembly 10.

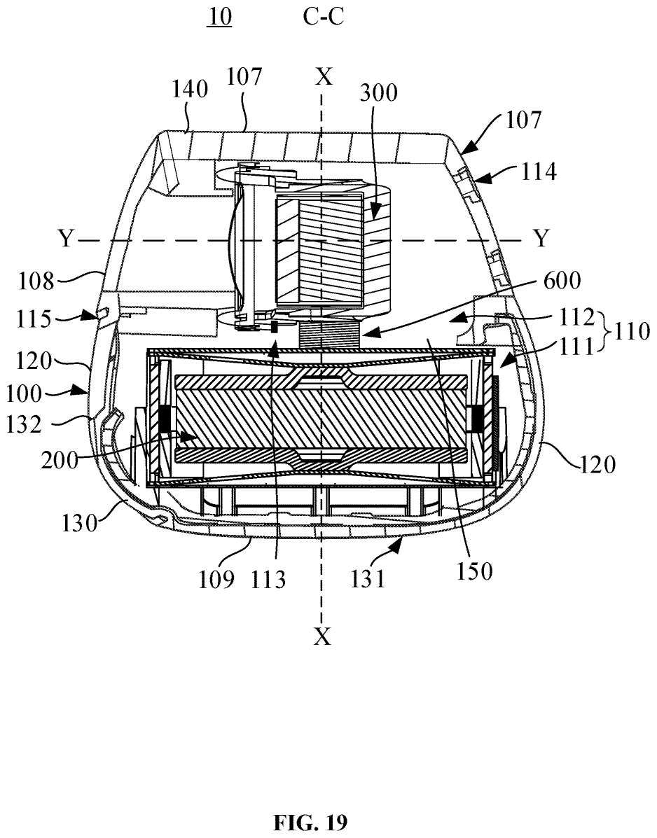

In some embodiments, as shown in FIG. 19, an elastic buffer member 600 may be disposed between the air-conduction core module 300 and the bone-conduction core module 200. The elastic buffer member 600 may be an elastic colloid (e.g., silica gel, rubber, or the like), a spring, an airbag, or a magnetic fluid. In this way, on one hand, the elastic buffer member 600 can reduce an influence and a limitation of the air-conduction core module 300 on the vibrations of the bone-conduction core module 200, such that the bone-conduction core module 200 vibrates more freely with improved vibration performance, and on the other hand, the elastic buffer member 600 may protect the air-conduction core module 300.

In some embodiments, at least one of the air-conduction core module 300 and the bone-conduction core module 200 may be fixed relative to the housing assembly 100. In some embodiments, the air-conduction core module 300 and the bone-conduction core module 200 may be fixedly connected to the housing assembly 100. In this way, operational stability of the bone-conduction core module 200 and the air-conduction core module 300 may be improved.

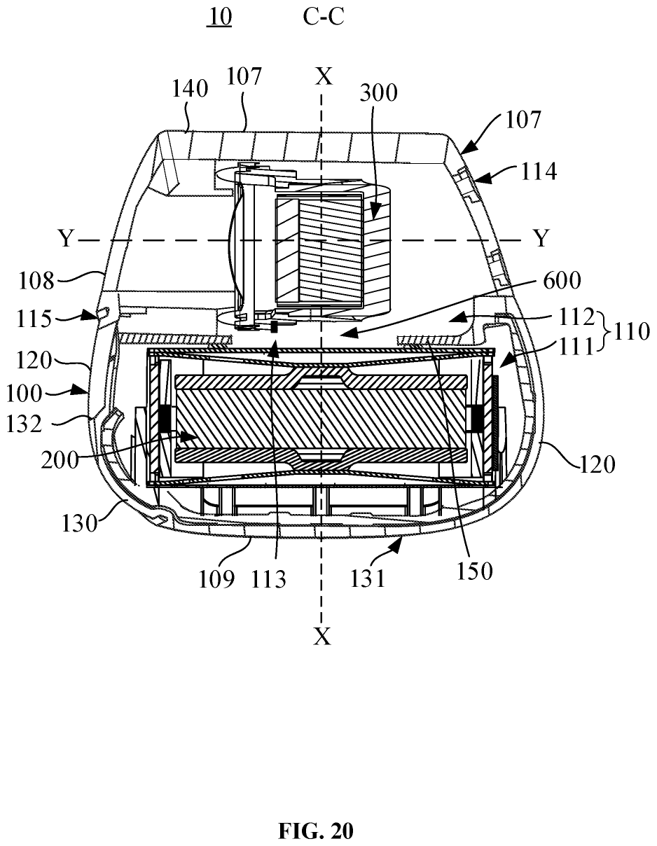

In some embodiments, as shown in FIG. 20, the air-conduction core module 300 and the bone-conduction core module 200 may be arranged at intervals in the first vibration direction. On one hand, an influence of a weight of the air-conduction core module 300 on a vibration bias of the bone-conduction core module 200 may be reduced, and on the other hand, the arrangement at intervals between the air-conduction core module 300 and the bone-conduction core module 200 may also reduce the mutual interference between vibrations of the bone-conduction core module 200 and the air-conduction core module 300, thereby reducing a possibility of vibration interference. In some embodiments, the air-conduction core module 300 may be fixedly connected to the housing assembly 100, such that when the bone-conduction core module 200 drives the housing assembly 100 to vibrate, the housing assembly 100 further drives the air-conduction core module 300 to vibrate.

In some embodiments, the housing assembly 100 may be provided with the partition wall 150, and the accommodating space 110 may include the first accommodating cavity 111 and the second accommodating cavity 112 that are separated by the partition wall 150. The bone-conduction core module 200 is disposed in the first accommodating cavity 111, and the air-conduction core module 300 is disposed in the second accommodating cavity 112.

In some embodiments, as shown in FIG. 19, the housing assembly 100 includes the first housing 120, the second housing 130, and the third housing 140. The second housing 130 is joined to the first housing 120 and cooperates with the first housing 120 to form the first accommodating cavity 111. The third housing 140 is joined to the first housing 120 and the second housing 130 and cooperates with the first housing 120 to form the second accommodating cavity 112. With the above arrangement, the speaker assembly 10 is convenient to assemble and disassemble.

Since the bone-conduction core module 200 requires an environment with strong airtightness to ensure the bone-conduction effect, the bone-conduction core module 200 and the air-conduction core module 300 are disposed in different cavities to improve the bone-conduction effect of the bone-conduction core module 200. In some embodiments, the first accommodating cavity 111 may be sealingly arranged so that the first accommodating cavity 111 has better airtightness.

In some embodiments, a shape and a dimension of the first accommodating cavity 111 match a shape and a dimension of the bone-conduction core module 200, thereby reducing the dimension of the speaker assembly 10 and facilitating the bone-conduction core module 200 to drive the housing assembly 100 to vibrate and transmit the bone conduction to the human body of the user.

In some embodiments, as shown in FIG. 20, the air-conduction core module 300 may generate the vibration in the second vibration direction, and the housing assembly 100 is provided with the sound outlet hole 114 and the one or more pressure relief holes 115 that are in communication with the second accommodating cavity 112. The sound outlet hole 114 is configured to transmit a part of sound waves generated by the air-conduction speaker 300 to the exterior of the speaker assembly 10, and the one or more pressure relief holes 115 are configured to connect the second accommodating cavity 112 with the external environment to ensure the air pressure balance inside the second accommodating cavity 112, thereby reducing the air pressure accumulation that affects the sound effect of the air-conduction speaker 300.

The sound outlet hole 114 and the one or more pressure relief holes 115 are respectively disposed on two side walls of the housing assembly 100 that are arranged at intervals in the second vibration direction. In this way, a mutual interference between sound waves transmitted through the sound outlet hole 114 and sound waves discharged through the one or more pressure relief holes 115 can be reduced, thereby improving the sound quality effect of the speaker assembly 10.

In some embodiments, as shown in FIG. 20, the bone-conduction core module 200 may have the first central axis X extending along the first vibration direction. The air-conduction core module 300 may generate a vibration in the second vibration direction and may have the second central axis Y extending along the second vibration direction. The angle between the first central axis X and the second central axis Y may be in a range of 70° to 100°.

For example, the angle between the first central axis X and the second central axis Y may be 80°, 85°, 90°, or the like. In some embodiments, the angle between the first central axis X and the second central axis Y may be 90°. In this way, a mutual interference between vibrations of the bone-conduction core module 200 and vibrations of the air-conduction core module 300 can be reduced, thereby ensuring the sound quality effect of the speaker assembly 10.

In some embodiments, as shown in FIG. 20, the second housing 130 may have a contact region 131 that is configured to contact the face of the user in a wearing state. A joint seam 132 between the first housing 120 and the second housing 130 is located outside the contact region 131. By arranging the joint seam 132 between the first housing 120 and the second housing 130 outside the contact region 131 instead of within the contact region 131, the joint seam 132 is less likely to pinch the skin of the human body when the earphone 1 is worn.

In some embodiments, the air-conduction core module 300 and the bone-conduction core module 200 may be arranged in sequence in the first vibration direction. In some embodiments, the bone-conduction core module 200 and the air-conduction core module 300 may have overlapping projections on a reference plane that is perpendicular to the first vibration direction.

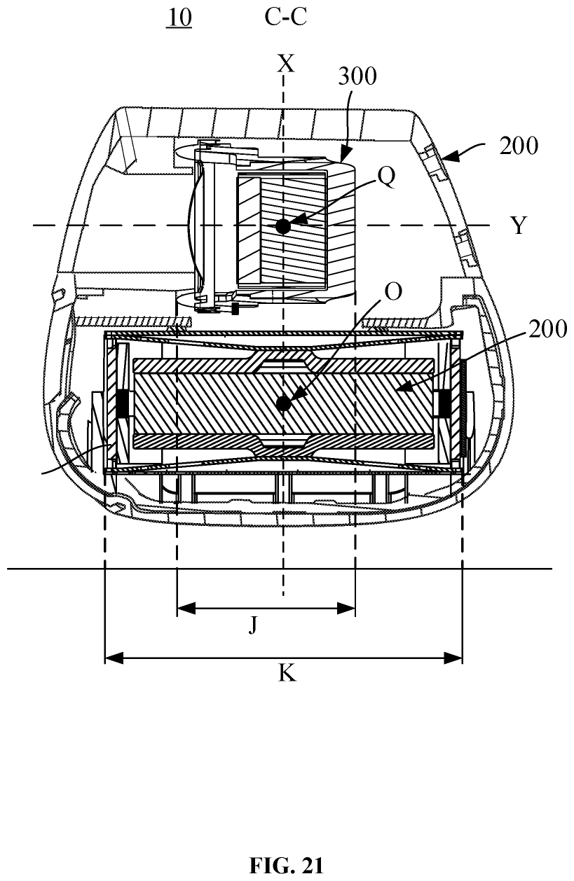

As shown in FIG. 21, the projection of the bone-conduction core module 200 on the reference plane perpendicular to the first vibration direction may be as indicated by K in FIG. 21, and the projection of the air-conduction core module 300 on the reference plane perpendicular to the first vibration direction may be as indicated by J in FIG. 21, wherein J and K have an overlapping region. In this way, when the bone-conduction core module 200 vibrates in the first vibration direction, the air-conduction core module 300 is driven to vibrate together with the bone-conduction core module 200.

The bone-conduction core module 200 has a relatively compact structure, so that the mass of the bone-conduction core module 200 is relatively concentrated and uniform. The vibration of the air-conduction core module 300 mainly comes from the diaphragm 310. The diaphragm 310 occupies a relatively large space but has a light mass, and the mass of the air-conduction core module 300 is mainly concentrated on a side deviating from the diaphragm 310, i.e., a side close to the magnetic circuit assembly 322. A volume of the bone-conduction core module 200 and a volume of the air-conduction core module 300 are specifically designed according to acoustic requirements. Therefore, the overlapping region of the bone-conduction core module 200 and the air-conduction core module 300 in the direction perpendicular to the first vibration direction is designed as follows.

In some embodiments, a ratio of the overlapping region to a projection area of the air-conduction core module 300 on the reference plane may be greater than 20%, greater than 40%, or greater than 60%. For example, the ratio of the overlapping region to the projection area of the air-conduction core module 300 on the reference plane may be 25%, 45%, 50%, or 100%.

In some embodiments, a ratio of the overlapping region to a projection area of the bone-conduction core module 200 on the reference plane may be greater than 20%, greater than 40%, or greater than 60%. For example, the ratio of the overlapping region to the projection area of the bone-conduction core module 200 on the reference plane may be 25%, 45%, 50%, or 100%.

In this way, by arranging the air-conduction core module 300 and the bone-conduction core module 200 in the described manner, a majority of a weight of the air-conduction core module 300 may effectively fall on the bone-conduction core module 200 in the first vibration direction, thereby reducing the influence of the air-conduction core module 300 on the vibration of the bone-conduction core module 200, improving the vibration effect of the bone-conduction core module 200, and enhancing the bone-conduction sound quality effect of the bone-conduction core module 200.

In some embodiments, as shown in FIG. 21, a distance between a projection of a center of mass of the bone-conduction core module 200 on the reference plane perpendicular to the first vibration direction and a projection of a center of mass of the air-conduction core module 300 on the reference plane may be less than 0.5 mm. The center of mass of the bone-conduction core module 200 may be indicated by point O in FIG. 20, and the center of mass of the air-conduction core module 300 may be indicated by point Q in FIG. 20.

In the direction perpendicular to the first vibration direction, the smaller the distance between the center of mass of the bone-conduction core module 200 and the center of mass of the air-conduction core module 300, the smaller an influence of a weight bias of the air-conduction core module 300 on the vibration of the bone-conduction core module 200, such that the vibration effect of the bone-conduction core module 200 is improved and the sound quality effect is also improved.

In some embodiments, the distance may range from 0 to 0.4 mm or 0 to 0.2 mm. For example, as shown in FIG. 20, the distance between the center of mass of the bone-conduction core module 200 and the center of mass of the air-conduction core module 300 may be 0 mm. The center of mass of the air-conduction core module 300 and the center of mass of the bone-conduction core module 200 are both located in the first vibration direction. In other words, in the reference plane perpendicular to the first vibration direction, the center of mass of the air-conduction core module 300 completely overlaps with the center of mass of the bone-conduction core module 200. Therefore, by setting the distance between the bone-conduction core module 200 and the air-conduction core module 300, different torques generated by vibrations of the bone-conduction core module 200 and the air-conduction core module 300 can be reduced, so that the bone-conduction core module 200 has the better bone-conduction effect, and the speaker assembly 10 has the better sound quality effect.

In other embodiments, on the reference plane perpendicular to the first vibration direction, the distance between the projection of the center of mass of the air-conduction core module 300 and the projection of the center of mass of the bone-conduction core module 200 may also be 0.1 mm, 0.25 mm, 0.3 mm, or the like. In this embodiment, detailed examples are not enumerated herein.

Alternatively, the bone-conduction core module 200 may have the first central axis X, and the first vibration direction is a direction of the first central axis X. A distance between the center of mass of the air-conduction core module 300 and the first central axis X is less than or equal to 0.5 mm. Similarly, the closer the center of mass of the air-conduction core module 300 is to the first central axis X, the smaller the influence of the air-conduction core module 300 on the vibration of the bone-conduction core module 200 is.

For example, as shown in FIG. 20, the distance between the center of mass of the air-conduction core module 300 and the first central axis X may be equal to 0 mm. By setting the distance between the center of mass of the air-conduction core module 300 and the first central axis X, the air-conduction core module 300 may be driven by the bone-conduction core module 200 to vibrate together along the direction of the first central axis X, so that the bone-conduction core module 200 has the better bone-conduction effect and the speaker assembly 10 has the better sound quality effect.

In other embodiments, the distance between the center of mass of the air-conduction core module 300 and the first central axis X may also be 0.1 mm, 0.2 mm, 0.3 mm, or the like. This embodiment is not described in further detail herein.

In some embodiments, as shown in FIG. 21, the bone-conduction core module 200 may be configured as a sealed structure, and the interior of the bone-conduction core module 200 may be isolated from the accommodating space 110.

In some embodiments, as shown in FIGS. 8 and 9, the bone-conduction speaker module 200 may include the cylindrical housing 210, the driving assembly 220, and the two sealing plates 230. The cylindrical housing 210 is fixedly connected to the housing assembly 100. The driving assembly 220 is disposed in the cylindrical housing 210 and configured to drive the cylindrical housing 210 to vibrate, thereby driving the housing assembly 100 to vibrate. The two sealing plates 230 are respectively disposed at two ends of the cylindrical housing 210 and block the cylindrical housing 210 to form the sealed structure.

Generating a vibration in the sealed cylindrical housing 210 makes the driving assembly 220 less susceptible to air resistance and other external factors during the vibration, thereby ensuring that the bone-conduction speaker module 200 has a better bone-conduction effect. In addition, during accidental dropping or impact of the earphone 1, the sealed cylindrical housing 210 may also prevent the driving assembly 220 from falling out of the cylindrical housing 210 and damaging internal structures, thereby improving structural stability of the bone-conduction speaker module 200.

In some embodiments, the bone-conduction speaker module 200 may include the vibration transmission plate 223. The driving assembly 220 includes the voice coil assembly 221 and the magnet assembly 222, and the voice coil assembly 221 is sleeved on the magnet assembly 222. The vibration transmission plate 223 is fixedly connected to the cylindrical housing 210 and the magnet assembly 222, and the voice coil assembly 221 is fixedly connected to the cylindrical housing 210. The voice coil assembly 221 is configured to receive an electrical signal and interact with the magnet assembly 222 to cause the magnet assembly 222 to generate a vibration. The magnet assembly 222 is configured to drive the cylindrical housing 210 to vibrate after interacting with the voice coil assembly 221. The vibration transmission plate 223 is configured to limit a position of the magnet assembly 222. In some embodiments, when the two sealing plates 230 cover the cylindrical housing 210 to form the sealed structure, the direction of the magnetic field can be better constrained, thereby making the vibration of the magnet assembly 222 more sensitive. The sealed structure may also prevent the vibration transmission plate 223 and the magnet assembly 222 from falling out of the cylindrical housing 210.

In some embodiments, the magnetic fluid may occupy at least a portion of an internal space of the cylindrical housing 210. The magnetic fluid, also referred to as magnetic liquid, ferromagnetic fluid, or ferrofluid, has the fluidity of a liquid and the magnetism of a solid magnetic material. Compared with air, the magnetic fluid has better magnetic conductivity, which can enhance the magnetic field effect of the magnet assembly 222 to make the vibration of the magnet assembly 222 more sensitive, thereby improving the bone conduction effect of the bone-conduction speaker module 200 and enhancing the sound quality effect of the speaker assembly 10.

In some embodiments, the magnetic fluid may not fill the entire internal space of the cylindrical housing 210. In this way, the fluid resistance can be reduced, and the bone conduction effect of the bone-conduction speaker module 200 can be improved.

Based on the above embodiments, the earphone 1 may include the speaker assembly 10 as described in the foregoing embodiments.

In summary, in the present disclosure, the two sealing plates 230 are disposed on two sides of the bone-conduction speaker 200 to close the cylindrical housing 210, so that a driving assembly 220 is limited within the accommodating space 211 of the cylindrical housing 210, thereby preventing the driving assembly 220 from easily falling out of the accommodating space 211, improving the sound quality of the bone-conduction speaker 200, and increasing the service life of the bone-conduction speaker 200.

The foregoing description is merely part of the embodiments of the present disclosure, and therefore should not be construed as limiting the scope of protection of the present disclosure. Any equivalent devices or equivalent process variations made based on the contents of the present disclosure and the accompanying drawings, or direct or indirect application thereof in other related technical fields, shall fall within the scope of patent protection of the present disclosure.

1. A bone-conduction speaker, comprising:
a cylindrical housing enclosing an accommodating space, wherein the cylindrical housing is a magnetic-conductive cover and is configured to constrain a direction of a magnetic field of a magnet assembly;
a driving assembly disposed within the accommodating space and connected with the cylindrical housing; and
two sealing plates respectively disposed at two ends of the cylindrical housing and blocking the accommodating space.

2. The bone-conduction speaker according to claim 1, wherein:
the bone-conduction speaker includes one or more vibration transmission plates, and the one or more vibration transmission plates are connected with the driving assembly and the cylindrical housing; and
in an axis direction of the cylindrical housing, the one or more vibration transmission plates are disposed between the driving assembly and the two sealing plates and arranged opposite to the two sealing plates.

3. The bone-conduction speaker according to claim 2, wherein:
one end of the cylindrical housing is configured in a stepped shape to form a first bearing surface and a second bearing surface with a step difference in the axis direction, and the second bearing surface is closer to an axis of the cylindrical housing than the first bearing surface;
the two sealing plates are fixedly supported on the first bearing surface; and
a peripheral edge of the one or more vibration transmission plates is fixedly supported on the second bearing surface.

4. The bone-conduction speaker according to claim 2, wherein:
the two sealing plates are fixedly connected with the two ends of the cylindrical housing; and
a peripheral edge of the one or more vibration transmission plates is fixed to an inner wall of the cylindrical housing.

5. The bone-conduction speaker according to claim 2, wherein:
the one or more vibration transmission plates are fixedly connected to one end of the cylindrical housing; and
one of the two sealing plates is fixedly stacked on a side of the one or more vibration transmission plates away from the driving assembly and is arranged at intervals from the cylindrical housing.

6. The bone-conduction speaker according to claim 2, wherein:
a count of the one or more vibration transmission plates is two, the two vibration transmission plates are respectively fixedly connected to the cylindrical housing, and the two sealing plates are correspondingly disposed on sides of the two vibration transmission plates away from the driving assembly.

7. The bone-conduction speaker according to claim 2, wherein:
the driving assembly includes a voice coil assembly and the magnet assembly, one of the voice coil assembly and the magnet assembly surrounds the other one of the voice coil assembly and the magnet assembly, and the one of the voice coil assembly and the magnet assembly is fixedly connected to the cylindrical housing;
the one or more vibration transmission plates are fixedly connected to the other one of the voice coil assembly and the magnet assembly and to the cylindrical housing;
the one or more vibration transmission plates and the two sealing plates are arranged opposite to each other in the axis direction of the cylindrical housing; and
the one or more vibration transmission plates are configured to elastically constrain a relative movement of the voice coil assembly and the magnet assembly in the axis direction of the cylindrical housing.

8. The bone-conduction speaker according to claim 7, wherein:
each of the one or more vibration transmission plates is disposed between the other one of the voice coil assembly and the magnet assembly and a corresponding sealing plate in the two sealing plates; and
the corresponding sealing plate is configured to rigidly constrain a deformation amplitude of the each of the one or more vibration transmission plates in the axis direction of the cylindrical housing to rigidly constrain a relative movement range of the voice coil assembly and the magnet assembly.

9. The bone-conduction speaker according to claim 8, wherein:
each of the one or more vibration transmission plates includes a central fixing portion, an annular fixing portion surrounding a periphery of the central fixing portion, and a connecting-rod assembly connected between the central fixing portion and the annular fixing portion, the annular fixing portion is connected to the cylindrical housing, and the central fixing portion is connected to the other one of the voice coil assembly and the magnet assembly; and
in a natural state, the central fixing portion and the corresponding sealing plate have a spacing in the axis direction of the cylindrical housing.

10. The bone-conduction speaker according to claim 9, wherein:
a distance between the central fixing portion and the corresponding sealing plate is in a range of 0.005 mm to 0.8 mm.

11. The bone-conduction speaker according to claim 9, wherein:
in the natural state, the central fixing portion is closer to the other one of the voice coil assembly and the magnet assembly in the axis direction than the annular fixing portion;
the magnet assembly includes a magnet and two magnetic conducting plates;
the two magnetic conducting plates are respectively disposed on two opposite side surfaces of the magnet in the axis direction; and
each of the two magnetic conducting plates has a protruding portion protruding toward the central fixing portion, and the protruding portion is fixedly connected to the central fixing portion.

12. The bone-conduction speaker according to claim 11, wherein:
the voice coil assembly includes two sets of voice coils arranged at intervals in the axis direction;
the cylindrical housing is disposed around a periphery of the two sets of voice coils;
projections of the two magnetic conducting plates in a radial direction of the bone-conduction speaker are at least partially overlapped with the two sets of voice coils; and
the two sets of voice coils have opposite energizing directions.

13. The bone-conduction speaker according to claim 1, wherein:
the accommodating space is filled with a magnetic fluid, and the magnetic fluid occupies at least a portion of the accommodating space.

14. An earphone, comprising:
a housing assembly provided with an accommodating space; and
a bone-conduction speaker, the bone-conduction speaker being disposed within the accommodating space, wherein the bone-conduction speaker includes:
a cylindrical housing enclosing an accommodating space, and the cylindrical housing being a magnetic-conductive cover and is configured to constrain a direction of a magnetic field of a magnet assembly;
a driving assembly disposed within the accommodating space and connected with the cylindrical housing; and
two sealing plates respectively disposed at two ends of the cylindrical housing and blocking the accommodating space.

15. The bone-conduction speaker according to claim 1, wherein:
the driving assembly includes a voice coil assembly, and the voice coil assembly includes two sets of voice coils; and
an outer side surface of the two sets of voice coils facing the cylindrical housing is attached and fixed to an inner side surface of the cylindrical housing facing the voice coil assembly.

16. The earphone according to claim 14, wherein:
the driving assembly includes a voice coil assembly, and the voice coil assembly includes two sets of voice coils; and
an outer side surface of the two sets of voice coils facing the cylindrical housing is attached and fixed to an inner side surface of the cylindrical housing facing the voice coil assembly.

17. The earphone according to claim 14, wherein:
the bone-conduction speaker includes one or more vibration transmission plates, and the one or more vibration transmission plates are connected with the driving assembly and the cylindrical housing; and
in an axis direction of the cylindrical housing, the one or more vibration transmission plates are disposed between the driving assembly and the two sealing plates and arranged opposite to the two sealing plates.

18. The earphone according to claim 17, wherein:
one end of the cylindrical housing is configured in a stepped shape to form a first bearing surface and a second bearing surface with a step difference in the axis direction, and the second bearing surface is closer to an axis of the cylindrical housing than the first bearing surface;
the two sealing plates are fixedly supported on the first bearing surface; and
a peripheral edge of the one or more vibration transmission plates is fixedly supported on the second bearing surface.

19. The earphone according to claim 17, wherein:
the two sealing plates are fixedly connected with the two ends of the cylindrical housing; and
a peripheral edge of the one or more vibration transmission plates is fixed to an inner wall of the cylindrical housing.

20. The earphone according to claim 17, wherein:
the one or more vibration transmission plates are fixedly connected to one end of the cylindrical housing; and
one of the two sealing plates is fixedly stacked on a side of the one or more vibration transmission plates away from the driving assembly and is arranged at intervals from the cylindrical housing.
